(19) United States
(12) Patent Application Publication
(10) Pub. No.: US 2014/0040946 A1
(43) Pub. Date: Feb. 6, 2014

(54) DYNAMIC CUSTOMIZATION OF AUDIO VISUAL CONTENT USING PERSONALIZING INFORMATION

(71) Applicant: Elwha LLC, a limited liability corporation of the State of Delaware, (US)

(72) Inventors: William H. Gates, III, Medina, WA (US); Daniel A. Gerrity, Seattle, WA (US); Pablos Holman, Seattle, WA (US); Roderick A. Hyde, Redmond, WA (US); Edward K.Y. Jung, Las Vegas, NV (US); Jordin T. Kare, Seattle, WA (US); Royce A. Levien, Lexington, MA (US); Robert W. Lord, Seattle, WA (US); Richard T. Lord, Tacoma, WA (US); Mark A. Malamud, Seattle, WA (US); Nathan P. Myhrvold, Bellevue, WA (US); John D. Rinaldo, JR., Bellevue, WA (US); Keith D. Rosema, Olympia, WA (US); Clarence T. Tegreene, Mercer Island, WA (US); Lowell L. Wood, JR., Bellevue, WA (US)

(73) Assignee: Elwha LLC, a limited liability corporation of the State of Delaware, Bellevue, WA (US)

(21) Appl. No.: 13/827,167

(22) Filed: Mar. 14, 2013

Related U.S. Application Data
(63) Continuation-in-part of application No. 13/801,079, filed on Mar. 13, 2013.
Application No. 13/801,079 is a continuation-in-part of application No. 13/720,727, filed on Dec. 19, 2012.
Application No. 13/720,727 is a continuation-in-part of application No. 13/714,195, filed on Dec. 13, 2012.
Application No. 13/714,195 is a continuation-in-part of application No. 13/708,632, filed on Dec. 7, 2012.
Application No. 13/708,632 is a continuation-in-part of application No. 13/689,488, filed on Nov. 29, 2012.
Application No. 13/689,488 is a continuation-in-part of application No. 13/602,058, filed on Aug. 31, 2012.
Application No. 13/602,058 is a continuation-in-part of application No. 13/566,723, filed on Aug. 3, 2012.

(51) Int. Cl. H04N 21/81

(52) U.S. Cl. CPC H04N 21/812
USPC 725/34

(57) ABSTRACT

Systems and methods for dynamic customization of advertising content are described. In some implementations, a process may include obtaining at least one customization input based at least partially on a personalizing information corresponding to at least one user, modifying at least part of an audio-visual content in accordance with the at least one customization input to create a dynamically customized audio-visual content, and providing the dynamically-customized audio-visual content.

### CROSS-REFERENCE TO RELATED APPLICATIONS

The present application is related to and/or claims the benefit of the earliest available effective filing date(s) from the following listed application(s) (the “Priority Applications”), if any, listed below (e.g., claims earliest available priority dates for other than provisional patent applications or claims benefits under 35 USC §119(e) for provisional patent applications, for any and all parent, grandparent, great-grandparent, etc. applications of the Priority Application(s)). In addition, the present application is related to the “Related Applications,” if any, listed below.

### PRIORITY APPLICATIONS

For purposes of the USPTO extra-statutory requirements, the present application constitutes a continuation-in-part of U.S. patent application Ser. No. 13/801,079, entitled Dynamic Customization of Audio Visual Content Using Personalizing Information, naming William H. Gates, III, Daniel A. Gerrity, Pablos Holman, Roderick A. Hyde, Edward K. Y. Jung, Jordin T. Kare, Royce A. Levien, Robert W. Lord, Richard T. Lord, Mark A. Malamud, Nathan P. Myhrvold, John D. Rinaldo, Jr., Keith D. Rosema, Clarence T. Tegreene, and Lowell L. Wood, Jr. as inventors, filed Mar. 13, 2013 with attorney docket no. SE1-0796-US, which is currently co-pending or is an application of which a currently co-pending application is entitled to the benefit of the filing date, and which is a continuation-in-part of U.S. patent application Ser. No. 13/720,727, entitled Methods and Systems for Viewing Dynamically Customized Advertising Content, naming William H. Gates, III, Daniel A. Gerrity, Paul Holman, Roderick A. Hyde, Edward K. Y. Jung, Jordin T. Kare, Royce A. Levien, Robert W. Lord, Richard T. Lord, Mark A. Malamud, Nathan P. Myhrvold, John D. Rinaldo, Jr., Keith D. Rosema, Clarence T. Tegreene, and Lowell L. Wood, Jr. as inventors, filed Dec. 19, 2012 with attorney docket no. SE1-0425-US, which is currently co-pending or is an application of which a currently co-pending application is entitled to the benefit of the filing date, and which is a continuation-in-part of U.S. patent application Ser. No. 13/714,195, entitled Dynamic Customization of Advertising Content, naming William H. Gates, III, Daniel A. Gerrity, Paul Holman, Roderick A. Hyde, Edward K. Y. Jung, Jordin T. Kare, Royce A. Levien, Robert W. Lord, Richard T. Lord, Mark A. Malamud, Nathan P. Myhrvold, John D. Rinaldo, Jr., Keith D. Rosema, Clarence T. Tegreene, and Lowell L. Wood, Jr. as inventors, filed Dec. 13, 2012 with attorney docket no. SE1-0424-US, which is currently co-pending or is an application of which a currently co-pending application is entitled to the benefit of the filing date, and which is a continuation-in-part of U.S. patent application Ser. No. 13/708,632, entitled Methods and Systems for Viewing Dynamically Customized Audio-Visual Content, naming William H. Gates, III, Daniel A. Gerrity, Paul Holman, Roderick A. Hyde, Edward K. Y. Jung, Jordin T. Kare, Royce A. Levien, Robert W. Lord, Richard T. Lord, Mark A. Malamud, Nathan P. Myhrvold, John D. Rinaldo, Jr., Keith D. Rosema, Clarence T. Tegreene, and Lowell L. Wood, Jr. as inventors, filed Dec. 7, 2012 with attorney docket no. SE1-0423-US, which is currently co-pending or is an application of which a currently co-pending application is entitled to the benefit of the filing date, and which is a continuation-in-part of U.S. patent application Ser. No. 13/689,488, entitled Methods and Systems for Viewing Dynamically Customized Audio-Visual Content, naming William H. Gates, III, Daniel A. Gerrity, Paul Holman, Roderick A. Hyde, Edward K. Y. Jung, Jordin T. Kare, Royce A. Levien, Robert W. Lord, Richard T. Lord, Mark A. Malamud, Nathan P. Myhrvold, John D. Rinaldo, Jr., Keith D. Rosema, Clarence T. Tegreene, and Lowell L. Wood, Jr. as inventors, filed Nov. 29, 2012, with attorney docket no. SE1-0422-US, which is currently co-pending or is an application of which a currently co-pending application is entitled to the benefit of the filing date, and which is a continuation-in-part of U.S. patent application Ser. No. 13/602,058, entitled Dynamic Customization and Monetization of Audio-Visual Content, naming William H. Gates, III, Daniel A. Gerrity, Paul Holman, Roderick A. Hyde, Edward K. Y. Jung, Jordin T. Kare, Royce A. Levien, Robert W. Lord, Richard T. Lord, Mark A. Malamud, Nathan P. Myhrvold, John D. Rinaldo, Jr., Keith D. Rosema, Clarence T. Tegreene, and Lowell L. Wood, Jr. as inventors, filed 31 Aug., 2012 with attorney docket no. SE1-0421-US, which is currently co-pending or is an application of which a currently co-pending application is entitled to the benefit of the filing date, and which is a continuation of U.S. patent application Ser. No. 13/566,723, entitled Dynamic Customization and Monetization of Audio-Visual Content, naming William H. Gates, III, Daniel A. Gerrity, Paul Holman, Roderick A. Hyde, Edward K. Y. Jung, Jordin T. Kare, Royce A. Levien, Robert W. Lord, Richard T. Lord, Mark A. Malamud, Nathan P. Myhrvold, John D. Rinaldo, Jr., Keith D. Rosema, Clarence T. Tegreene, and Lowell L. Wood, Jr. as inventors, filed 3 Aug., 2012 with attorney docket no. SE1-0420-US.

### RELATED APPLICATIONS

None.

The United States Patent Office (USPTO) has published a notice to the effect that the USPTO's computer programs require that patent applicants reference both a serial number and indicate whether an application is a continuation, continuation-in-part, or divisional of a parent application. Stephen G. Kunin, Benefit of Prior-Filed Application, USPTO Official Gazette Mar. 18, 2003. The USPTO further has provided forms for the Application Data Sheet which allow automatic loading of bibliographic data but which require identification of each application as a continuation, continuation-in-part, or divisional of a parent application. The present Applicant Entity (hereinafter “Applicant”) has provided above a specific reference to the application(s) from which priority is being claimed as recited by statute. Applicant understands that the statute is unambiguous in its specific reference language and does not require either a serial number or any characterization, such as “continuation” or “continuation-in-part,” for claiming priority to U.S. patent applications. Notwithstanding the foregoing, Applicant understands that the USPTO's computer programs have certain data entry requirements, and hence Applicant has provided designation(s) of a relationship between the present application and its parent application(s) as set forth above and in any ADS filed in this application, but expressly points out that such designation(s) are not to be construed in any way as any type of commentary and/or admission as to whether or not the present application contains any new matter in addition to the matter of its parent application(s).

If the listings of applications provided above are inconsistent with the listings provided via an ADS, it is the intent of the Applicant to claim priority to each application that appears in the Priority Applications section of the ADS and to each application that appears in the Priority Applications section of this application.

All subject matter of the Priority Applications and the Related Applications and of any and all parent, grandparent, great-grandparent, etc. applications of the Priority Applications and the Related Applications, including any priority claims, is incorporated herein by reference to the extent such subject matter is not inconsistent herewith.

### FIELD OF THE DISCLOSURE

The present disclosure relates generally to dynamic customization of advertising content associated with audio-visual broadcasts (e.g. television broadcasts, data streams, etc.).

### BACKGROUND

Conventional audio-visual content streams, including television broadcasts or the like, typically consist of either pre-recorded content or live events that do not allow viewers to interact with or control any of the audio-visual content that is displayed. Various concepts have recently been introduced that allow for television broadcasts to be modified to a limited degree to accommodate viewer choices, as disclosed by U.S. Pat. Nos. 7,945,926 and 7,631,327 entitled “Enhanced Custom Content Television” issued to Dempski et al. Such prior art systems and methods are relatively limited, however, in their ability to accommodate and assimilate viewer-related information to provide a dynamically tailored audio-visual content stream. Systems and methods for dynamically customized audio-visual broadcasts, and systems and methods for dynamic customization of advertising content associated with audio-visual broadcasts, that provide an improved degree of accommodation or assimilation of viewer-related choices and characteristics would have considerable utility.

### SUMMARY

The present disclosure teaches systems and methods for dynamic customization of advertising content associated with audio-visual content, such as television broadcasts, internet streams, podcasts, audio broadcasts, and the like. For example, in at least some implementations, a process in accordance with the teachings of the present disclosure may include may include obtaining at least one customization input based at least partially on a personalizing information corresponding to at least one user, modifying at least part of an audio-visual content in accordance with the at least one customization input to create a dynamically customized audio-visual content, and providing the dynamically-customized audio-visual content

This summary is intended to provide an introduction of a few exemplary aspects of implementations in accordance with the present disclosure. It is not intended to provide an exhaustive explanation of all possible implementations, and should thus be construed as merely introductory, rather than limiting, of the following disclosure.

### BRIEF DESCRIPTION OF THE DRAWINGS

FIGS. 1-6 show schematic views of systems for dynamic customization and monetization of audio-visual content in accordance with possible implementations of the present disclosure.

FIGS. 7 through 24 are flowcharts of processes for dynamic customization of advertising content associated with audio-visual content in accordance with further possible implementations of the present disclosure.

### DETAILED DESCRIPTION

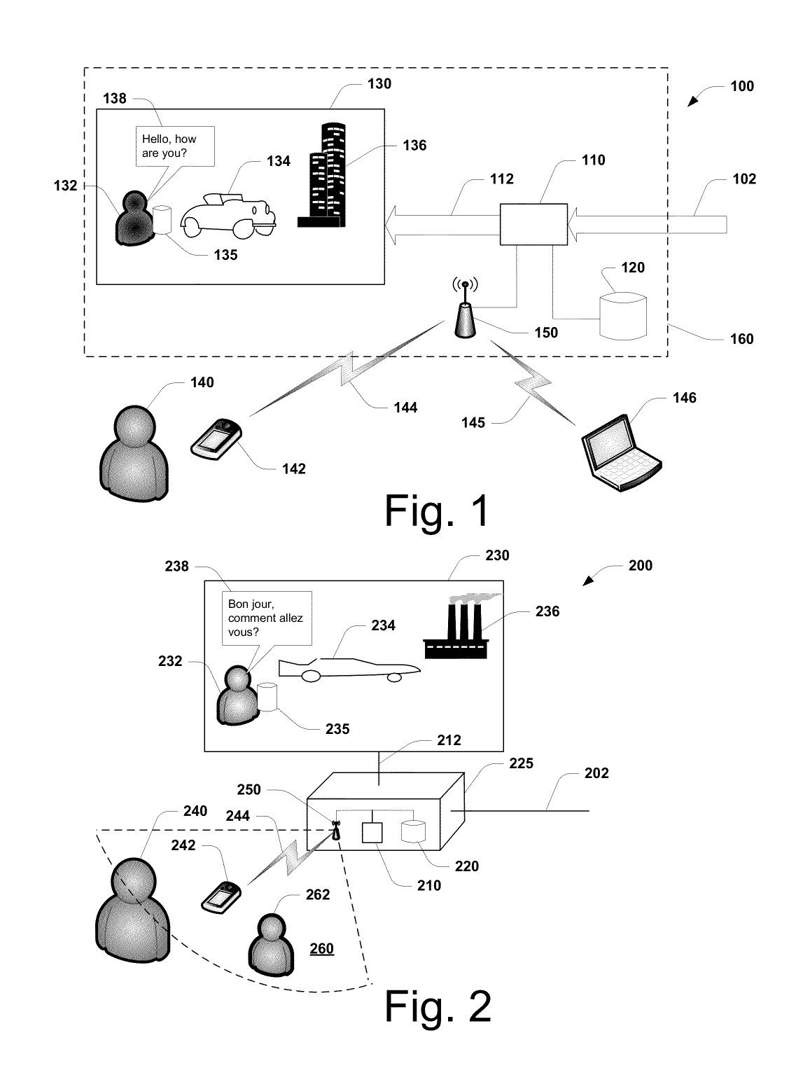

Techniques for dynamic customization of audio-visual content, such as television broadcasts or other audio-visual content streams, and for dynamic customization of advertising associated with such audio-visual content, will now be disclosed in the following detailed description. It will be appreciated that many specific details of certain implementations will be described and shown in FIGS. 1 through 24 to provide a thorough understanding of such implementations. One skilled in the art will understand, however, that the present disclosure may have other possible implementations, and that such other implementations may be practiced with or without some of the particular details set forth in the following description.

In the following discussion, exemplary systems or environments for implementing one or more of the teachings of the present disclosure are described first. Next, exemplary flow charts showing various embodiments of processes for dynamic customization and monetization of audio-visual content in accordance with one or more of the teachings of the present disclosure are described.

Exemplary Systems for Dynamic Customization and Monetization of Audio-Visual Content

Embodiments of methods and systems in accordance with the present disclosure may be implemented in a variety of environments. Initially, methods and systems in accordance with the present disclosure will be described in terms of dynamic customization of broadcasts. It should be remembered, however, that inventive aspects of such methods and systems may be applied to other environments that involve audio-visual content streams, and are not necessarily limited to the specific audio-visual broadcast implementations shown herein.

FIG. 1 is a schematic view of a representative system 100 for dynamic customization and monetization of audio-visual content in accordance with an implementation of the present disclosure. In this implementation, the system 100 includes a processing component 110 that receives an audio-visual core portion 102, such as a television broadcast, and provides a dynamically customized audio-visual content 112 to a display 130. In some implementations, a viewer 140 uses a control device 142 to provide one or more selection signals 144 to a sensor 150 which, in turn, provides inputs corresponding to the selection signals 144 to the processing component 110. Alternately, the processing component 110 may operate without selection signals 144, such as by accessing default inputs stored within a memory. In some embodiments, the sensor 150 may receive further supplemental selection signals 145 from a processing device 146 (e.g. laptop, desktop, personal data assistant, cell phone, iPad, iPhone, etc.) associated with the viewer 140.

As described more fully below, based on the one or more selection signals 144 (or default inputs if specific inputs are not provided), the processing component 110 may modify one or more aspects of the incoming audio-visual core portion 102 to provide the dynamically customized audio-visual content 112 that is shown on the display 130. In at least some implementations, the processing component 110 may access a data store 120 having revised content portions stored therein to perform one or more aspects of the processes described below.

In at least some implementations, the processing component 110 may modify the core portion 102 by a rendering process. The rendering process is preferably a real-time (or approximately real-time) process. The rendering process may receive the core portion 102 as a digital signal stream, and may modify one or more aspects of the core portion 102, such as by replacing one or more portions of the core portion 102 with one or more revised content portions retrieved from the data store 120, in accordance with the selection signals 144 (and/or default inputs). It should be appreciated that, in some embodiments, the audio-visual core portion 102 may consist of solely an audio portion, or solely a visual (or video) portion, or may include a separate audio portion and a separate visual portion. In further embodiments, the audio-visual core portion 102 may include a plurality of audio portions or a plurality of visual portions, or any suitable combination thereof.

As used herein, the term “visual” in such phrases as “audio-visual portion,” “audio-visual core portion,” “visual portion,” etc. is used broadly to refer to signals, data, information, or portions thereof that are associated with something which may eventually be viewed on a suitable display device by a viewer (e.g. video, photographs, images, etc.). It should be understood that a “visual portion” is not intended to mean that the signals, data, information, or portions thereof are themselves visible to a viewer. Similarly, as used herein, the term “audio” in such phrases as “audio-visual portion,” “audio-visual core portion,” “audio portion,” etc. is used broadly to refer to signals, data, information, or portions thereof that are associated with something which may eventually produce sound on a suitable output device to a listener, and are not intended to mean that the signals, data, information, or portions thereof are themselves audible to a listener.

It will be appreciated that the components of the system 100 shown in FIG. 1 are merely exemplary, and represent one possible implementation of a system in accordance with the present disclosure. The various components of the system 100 may communicate and exchange information as needed to perform the functions and operations described herein. More specifically, in various implementations, each of the components of the system 100 may be implemented using software, hardware, firmware, or any suitable combinations thereof. Similarly, one or more of the components of the system 100 may be combined, or may be divided or separated into additional components, or additional components may be added, or one or more of the components may simply be eliminated, depending upon the particular requirements or specifications of the operating environment.

It will be appreciated that other suitable embodiments of systems for dynamic customization of audio-visual broadcasts may be conceived. For example, in some embodiments, the display 130 may be that associated with a conventional television or other conventional audio-visual display device, and the processing component 110 may be a separate component, such as a gaming device (e.g. Microsoft Xbox®, Sony Playstation®, Nintendo Wii®, etc.), a media player (e.g. DVD player, Blu Ray device, Tivo, etc.), or any other suitable component. Similarly, the sensor 150 may be a separate component or may alternately be integrated into the same component with the display 130 or the processing component 110. Similarly, the information store 120 may be a separate component or may alternately be integrated into the same component with the processing component 110, the display 130, or the sensor 150. Alternately, some or all of the components (e.g. the processing component 110, the information store 120, the display 130, the sensor 150, etc.) may be integrated into a common component 160.

FIG. 2 is a schematic view of another representative system 200 for dynamic customization of television broadcasts in accordance with an implementation of the present disclosure. In this implementation, the system 200 includes a processing component 210 that receives an audio-visual core portion 202, and provides a dynamically customized audio-visual content 212 to a display 230. A viewer 240 uses a control device 242 to provide one or more selection signals 244 to a sensor 250 which, in turn, provides inputs corresponding to the selection signals 244 to the processing component 210. As described above, the processing component 210 may also operate without selection signals 244, such as by accessing default inputs stored within a memory 220. The sensor 250 may sense a field of view 260 to detect the viewer 240 or other one or more other persons 262. In the implementation shown in FIG. 2, the processing component 210, the memory 220, and the sensor 250 are housed within a single device 225.

As described more fully below, based on the one or more selection signals 244 (or default inputs if specific inputs are not provided), the processing component 210 may modify one or more aspects of the incoming audio-visual core portion 202 to provide the dynamically customized audio-visual content 212 that is shown on the display 230. The processing component 210 may also modify one or more aspects of the incoming audio-visual core portion 202 based on one or more persons (e.g. viewer 240, other person 262) sensed within the filed of view 260. In at least some implementations, the processing component 210 may retrieve revised content portions stored in the memory 220 to perform one or more aspects of the processes described below.

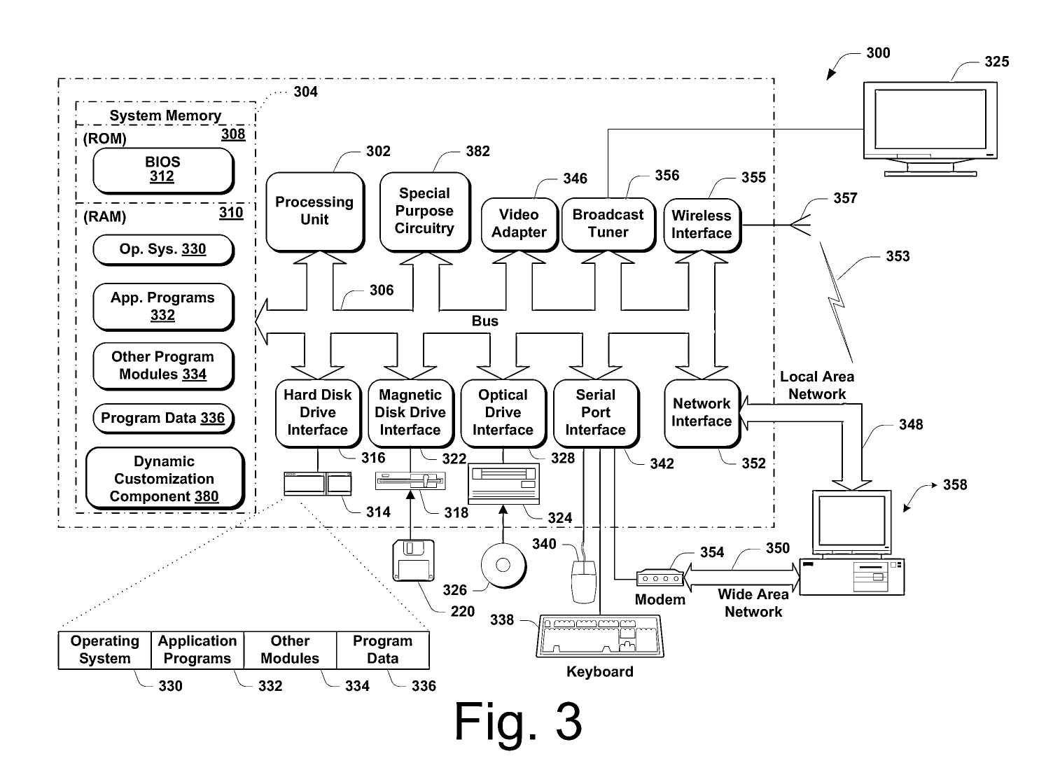

FIG. 3 shows another representative implementation of a system 300 for dynamic customization of audio-visual content in accordance with another possible embodiment. In this implementations the system 300 may include one or more processors (or processing units) 302, special purpose circuitry 382, a memory 304, and a bus 306 that couples various system components, including the memory 304, to the one or more processors 302 and special purpose circuitry 382 (e.g. ASIC, FPGA, etc.). The bus 306 represents one or more of any of several types of bus structures, including a memory bus or memory controller, a peripheral bus, an accelerated graphics port, and a processor or local bus using any of a variety of bus architectures. In this implementation, the memory 304 includes read only memory (ROM) 308 and random access memory (RAM) 310. A basic input/output system (BIOS) 312, containing the basic routines that help to transfer information between elements within the system 300, such as during start-up, is stored in ROM 308.

The exemplary system 300 further includes a hard disk drive 314 for reading from and writing to a hard disk (not shown), and is connected to the bus 306 via a hard disk driver interface 316 (e.g., a SCSI, ATA, or other type of interface). A magnetic disk drive 318 for reading from and writing to a removable magnetic disk 320, is connected to the system bus 306 via a magnetic disk drive interface 322. Similarly, an optical disk drive 324 for reading from or writing to a removable optical disk 326 such as a CD ROM, DVD, or other optical media, connected to the bus 306 via an optical drive interface 328. The drives and their associated computer-readable media provide nonvolatile storage of computer readable instructions, data structures, program modules and other data for the system 300. Although the exemplary system 300 described herein employs a hard disk, a removable magnetic disk 320 and a removable optical disk 326, it should be appreciated by those skilled in the art that other types of computer readable media which can store data that is accessible by a computer, such as magnetic cassettes, flash memory cards, digital video disks, random access memories (RAMs) read only memories (ROM), and the like, may also be used.

As further shown in FIG. 3, a number of program modules may be stored on the memory 304 (e.g. the ROM 308 or the RAM 310) including an operating system 330, one or more application programs 332, other program modules 334, and program data 336 (e.g. the data store 320, image data, audio data, three dimensional object models, etc.). Alternately, these program modules may be stored on other computer-readable media, including the hard disk, the magnetic disk 320, or the optical disk 326. For purposes of illustration, programs and other executable program components, such as the operating system 330, are illustrated in FIG. 3 as discrete blocks, although it is recognized that such programs and components reside at various times in different storage components of the system 300, and may be executed by the processor(s) 302 or the special purpose circuitry 382 of the system 300.

A user may enter commands and information into the system 300 through input devices such as a keyboard 338 and a pointing device 340. Other input devices (not shown) may include a microphone, joystick, game pad, satellite dish, scanner, or the like. These and other input devices are connected to the processing unit 302 and special purpose circuitry 382 through an interface 342 that is coupled to the system bus 306. A monitor 325 (e.g. display 130, display 230, or any other display device) may be connected to the bus 306 via an interface, such as a video adapter 346. In addition, the system 300 may also include other peripheral output devices (not shown) such as speakers and printers.

The system 300 may operate in a networked environment using logical connections to one or more remote computers (or servers) 358. Such remote computers (or servers) 358 may be a personal computer, a server, a router, a network PC, a peer device or other common network node, and may include many or all of the elements described above relative to system 300. The logical connections depicted in FIG. 3 may include one or more of a local area network (LAN) 348 and a wide area network (WAN) 350. Such networking environments are commonplace in offices, enterprise-wide computer networks, intranets, and the Internet. In this embodiment, the system 300 also includes one or more broadcast tuners 356. The broadcast tuner 356 may receive broadcast signals directly (e.g., analog or digital cable transmissions fed directly into the tuner 356) or via a reception device (e.g., via sensor 150, sensor 250, an antenna, a satellite dish, etc.).

When used in a LAN networking environment, the system 300 may be connected to the local network 348 through a network interface (or adapter) 352. When used in a WAN networking environment, the system 300 typically includes a modem 354 or other means for establishing communications over the wide area network 350, such as the Internet. The modem 354, which may be internal or external, may be connected to the bus 306 via the serial port interface 342. Similarly, the system 300 may exchange (send or receive) wireless signals 353 (e.g. selection signals 144, signals 244, core portion 102, core portion 202, etc.) with one or more remote devices (e.g. remote 142, remote 242, computers 258, etc.), using a wireless interface 355 coupled to a wireless communicator 357 (e.g., sensor 150, sensor 250, an antenna, a satellite dish, a transmitter, a receiver, a transceiver, a photoreceptor, a photodiode, an emitter, a receptor, etc.).

In a networked environment, program modules depicted relative to the system 300, or portions thereof, may be stored in the memory 304, or in a remote memory storage device. More specifically, as further shown in FIG. 3, a dynamic customization component 380 may be stored in the memory 304 of the system 300. The dynamic customization component 380 may be implemented using software, hardware, firmware, or any suitable combination thereof. In cooperation with the other components of the system 300, such as the processing unit 302 or the special purpose circuitry 382, the dynamic customization component 380 may be operable to perform one or more implementations of processes for dynamic customization in accordance with the present disclosure.

It will be appreciated that while the system 300 shown in FIG. 3 is capable of receiving an audio-visual core portion (e.g. core portion 102, core portion 202, etc.) from an external source (e.g. via the wireless device 357, the LAN 348, the WAN 350, etc.), in further embodiments, the audio-visual core portion may itself be generated within the system 300, such as by playing media stored within the system memory 304, or stored within the hard disk drive 314, or played on the disk drive 318, the optical drive 328, or any other suitable component of the system 300. In some implementations, the audio-visual core portion may be generated by suitable software routines operating within the system 300.

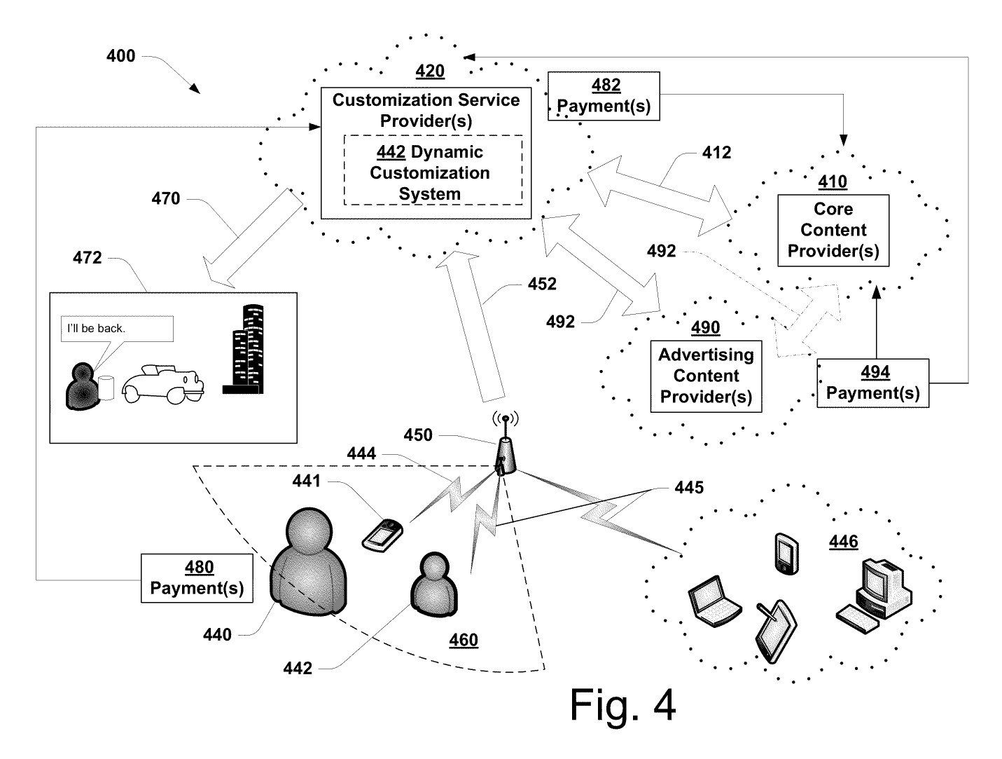

FIG. 4 is a schematic view of a representative system 400 for dynamic customization of audio-visual content in accordance with an alternate implementation of the present disclosure. In this implementation, the system 400 includes one or more core content providers 410 that provide one or more audio-visual core portions 412 to one or more customization service providers 420. The one or more customization service providers 420 include at least one dynamic customization system 422, which may include one or more of the components described above with respect to FIGS. 1-3.

As further shown in FIG. 4, one or more advertising content providers 490 may provide one or more advertising content portions 492 to the one or more customization service providers 420 which may perform dynamic customization of the one or more advertising content portions 492. Alternately, the one or more advertising content providers 490 may provide one or more advertising content portions 492 to the one or more core content providers 410, which may in turn incorporate (or otherwise include) the one or more advertising content portions 492 into (or with) the one or more audio-visual core portions 412.

It will be appreciated that, in at least some implementations, one or more of the core content providers 410, or one or more of the customization service providers 420, may be based or partially based in what is referred to as the “cloud” or “cloud computing,” or may be provided using one or more “cloud services.” For the purposes of this application, cloud computing is the delivery of computational capacity and/or storage capacity as a service. The “cloud” refers to one or more hardware and/or software components that deliver or assist in the delivery of computational and/or storage capacity, including, but not limited to, one or more of a client, an application, a platform, an infrastructure, and a server, and associated hardware and/or software. Cloud and cloud computing may refer to one or more of a computer, a processor, a storage medium, a router, a modem, a virtual machine (e.g., a virtual server), a data center, an operating system, a middleware, a hardware back-end, a software back-end, and a software application. A cloud may refer to a private cloud, a public cloud, a hybrid cloud, and/or a community cloud. A cloud may be a shared pool of configurable computing resources, which may be public, private, semi-private, distributable, scaleable, flexible, temporary, virtual, and/or physical. A cloud or cloud service may be delivered over one or more types of network, e.g., the Internet.

As used in this application, a cloud or cloud services may include one or more of infrastructure-as-a-service (“IaaS”), platform-as-a-service (“Paas”), software-as-a-service (“SaaS”), and desktop-as-a-service (“DaaS”). As a non-exclusive example, IaaS may include, e.g., one or more virtual server instantiations that may start, stop, access, and configure virtual servers and/or storage centers (e.g., providing one or more processors, storage space, and network resources on-demand, e.g., GoGrid and Rackspace). PaaS may include, e.g., one or more software and/or development tools hosted on an infrastructure (e.g., a computing platform and/or a solution stack from which the client can create software interfaces and applications, e.g., Microsoft Azure. SaaS may include, e.g., software hosted by a service provider and accessible over a network (e.g., the software for the application and the data associated with that software application are kept on the network, e.g., Google Apps, SalesForce). DaaS may include, e.g., providing desktop, applications, data, and services for the user over a network (e.g., providing a multi-application framework, the applications in the framework, the data associated with the applications, and services related to the applications and/or the data over the network, e.g., Citrix). The foregoing is intended to be exemplary of the types of systems referred to in this application as “cloud” or “cloud computing” and should not be considered complete or exhaustive.

As further shown in FIG. 4, a viewer 440 may provide one or more selection signals 444 using a manual input device 441. In some implementations, the one or more selections signals 444 may be provided to a sensor 450 which, in turn, provides selection inputs 452 corresponding to the selection signals 444 to the one or more dynamic customization service providers 420. Alternately, the sensor 450 may be eliminated, and the selection signals 444 may be communicated directly to the one or more dynamic customization service providers 420.

As further shown in FIG. 4, in some embodiments, the sensor 450 may receive one or more supplemental selection signals 445 from one or more electronic devices 446 (e.g. laptop, desktop, personal data assistant, cell phone, iPad, iPhone, etc.) associated with the viewer 440. As described above, the one or more supplemental selection signals 445 may be based on a variety of suitable information, including, for example, browsing histories, purchase records, call records, downloaded content, or any other suitable information or data. In some implementations, one or more supplemental selection signals 445 may be automatically determined from one or more characteristics of a viewing area 460, such as a presence of one or more additional viewers 442 (e.g. a child, spouse, friend, visitor, etc.).

In operation, the one or more customization service providers 420 receive the one or more selection inputs 452 (or default inputs if specific inputs are not provided), and the audio-visual core portion 412 from the one or more core content providers 410, and using the one or more dynamic customization systems 422, provide a dynamically customized audio-visual content 470 to a display 472 visible to the one or more viewers 440, 442 in the viewing area 460. In some embodiments, the one or more customization service providers 420 may dynamically customize the one or more audio-visual core portions 412, or the one or more advertising content portions 492, or both.

In at least some embodiments, one or more viewers 440, 442 may provide one or more payments (or other consideration) 480 to the one or more customization service providers 420 in exchange for the dynamically customized audio-visual content 470. Similarly, in at least some embodiments the one or more customization service providers 420 may provide one or more payments (or other consideration) 482 to the one or more core content providers 410 in exchange for the core audio-visual content 412. In some embodiments, the amounts of at least a portion of the one or more payments 480, or the one or more payments 482, may be at least partially determined using one or more processes in accordance with the teachings of the present disclosure, as described more fully below.

Similarly, in at least some embodiments, one or more payments (or other consideration) 494 may be provided by the one or more advertising content providers 490 to the one or more core content providers 410, to the one or more customization service providers 420, or both. Again, the amounts of at least a portion of the one or more payments 494 may be at least partially determined using one or more processes in accordance with the teachings of the present disclosure, as described more fully below.

It should be appreciated that, in some embodiments, the audio-visual core portion 412 may consist of solely an audio portion, or solely a visual (or video) portion, a separate audio portion, a separate visual portion, a plurality of audio portions, a plurality of visual portions, or any suitable combination thereof. Similarly, in various embodiments, the dynamically customized audio-visual core portion 470 may consist of solely an audio portion, or solely a visual (or video) portion, a separate audio portion, a separate visual portion, a plurality of audio portions, a plurality of visual portions, or any suitable combination thereof.

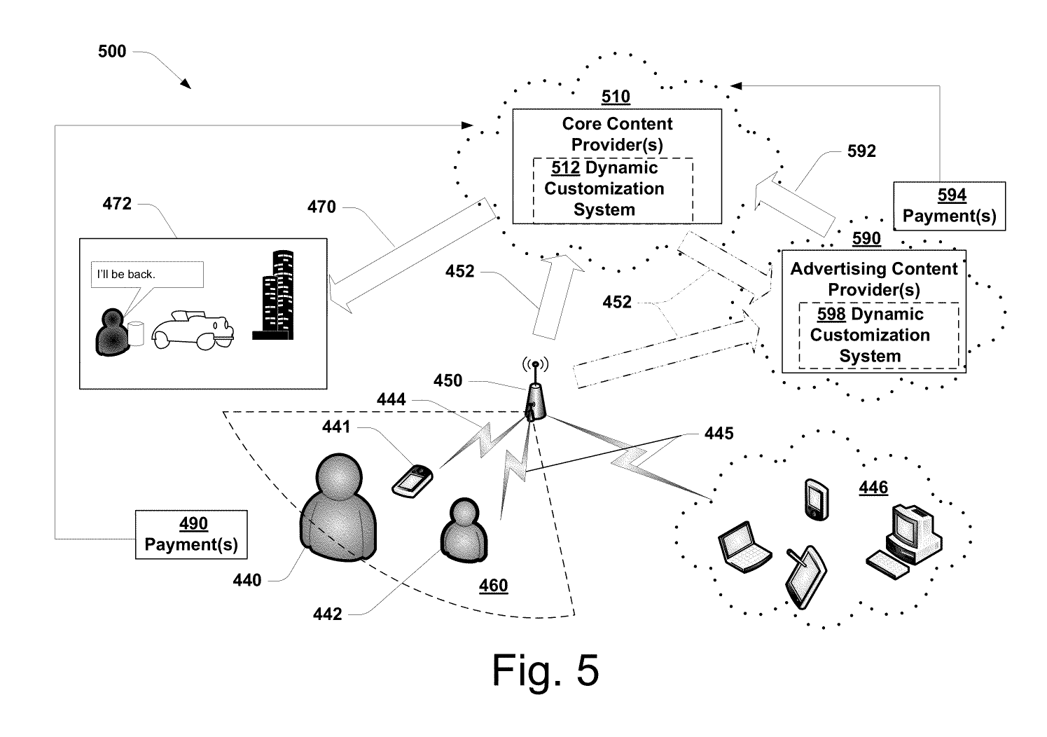

FIG. 5 shows a schematic view of another representative system 500 for dynamic customization of audio-visual broadcasts in accordance with an alternate implementation of the present disclosure. It will be appreciated that, in this implementation, the system 500 may include several of the same or substantially similar components as described above for the system 500 shown in FIG. 5, however, the one or more customization service providers 420 have been eliminated. For the sake of brevity, a detailed description of such previously-described components will not be repeated, but rather, new aspects of the system 500 shown in FIG. 5 will be described.

As shown in FIG. 5, in some implementations, the one or more selection inputs 452 are provided to one or more core content providers 510. The one or more core content providers 510 have one or more dynamic customization systems 512. One or more advertising content providers 590 provide one or more advertising content portions 592 to the one or more core content providers 510.

In operation, the one or more core content providers 510 receive the one or more selection inputs 452 (or default inputs if specific inputs are not provided), and modify an audio-visual core portion using the one or more dynamic customization systems 512 to provide a dynamically customized audio-visual content 470 to a display 472 visible to one or more viewers 440, 442 in a viewing area 460. Thus, in at least some implementations, the one or more customization service providers 420 shown in FIG. 4 may be eliminated, and the same one or more entities that normally provide an audio-visual core portion (e.g. normal television broadcasts, etc.) may perform the dynamic customization to provide the desired dynamically customized audio-visual content to viewers.

In some implementations, the one or more advertising content providers 590 may receive the one or more selection inputs 452 (e.g. from the sensor 450 as shown in FIG. 5, or from the one or more core content providers 510, or from any other suitable source). Furthermore, in such implementations, the one or more advertising content providers 590 may include a dynamic customization system 598, and may provide one or more dynamically customized advertising content portions 592 to the one or more core content providers 510, using one or more techniques as described more fully below.

In at least some embodiments, the one or more viewers 440, 442 may provide one or more payments (or other consideration) 490 to the one or more core content providers 510 in exchange for the dynamically customized audio-visual content 470. In some embodiments, the amount of at least part of the one or more payments 490 may be defined using one or more processes in accordance with the teachings of the present disclosure, as described more fully below. Similarly, in at least some implementations, the one or more advertising content providers 590 may provide one or more payments (or other consideration) 594 to the one or more core content providers 510. Again, in some implementations, the amount of at least part of the one or more payments 594 may be determined using one or more processes in accordance with the teachings of the present disclosure, as described more fully below.

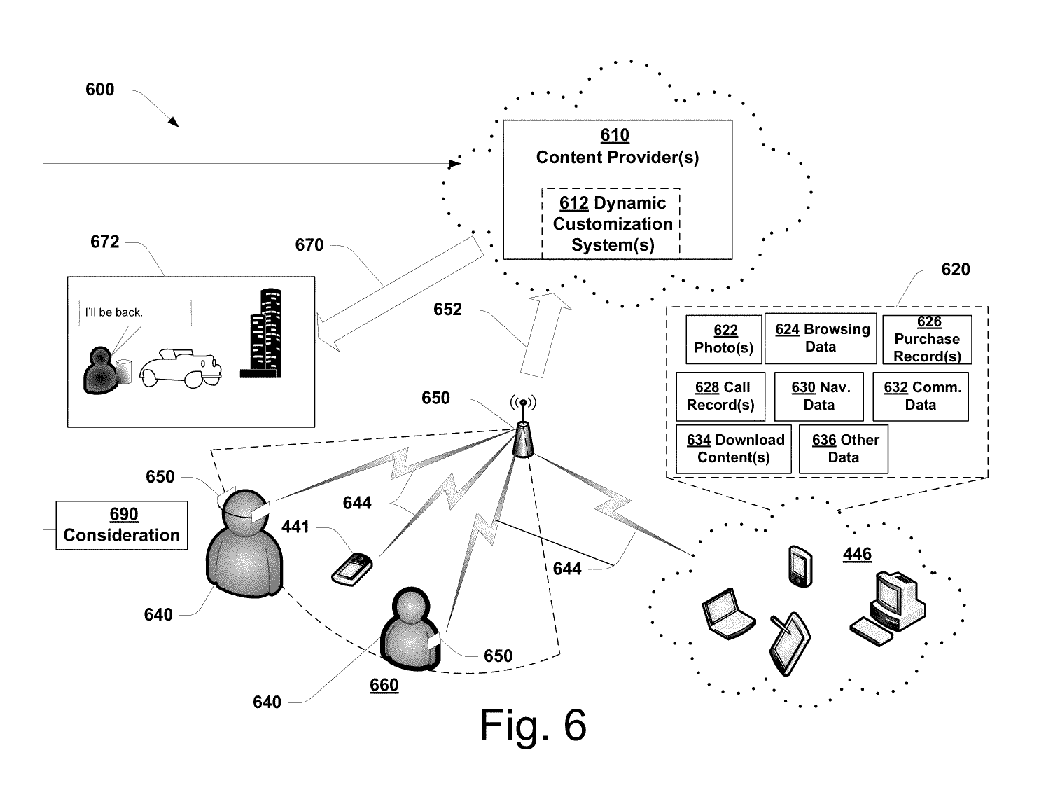

FIG. 6 shows a schematic view of another representative system 600 for dynamic customization of audio-visual broadcasts in accordance with an alternate implementation of the present disclosure. Again, it will be appreciated that, in this implementation, the system 600 may include several of the same components as described above with respect to the preceeding figures and therefore, for the sake of brevity, a detailed description of such components will not be repeated, but rather, significant new aspects of the system 600 shown in FIG. 6 will be described.

As shown in FIG. 6, in at least some implementations, the system 600 may include one or more content providers 610 that receive one or more customization inputs 652, and provide one or more dynamically-customized audio-visual outputs 670. The one or more core content providers 610 may provide any suitable type of audio-visual content, including core content, advertising content, one or more visual contents, one or more audio contents, one or more audio-visual contents, etc. In some implementations, at least some of the one or more content providers 610 may include one or more dynamic customization systems 612.

As further depicted in FIG. 6, one or more sensors 650 may receive one or more customization signals (or personalizing information) 644 from one or more users 640 in a sensing area 660, and in turn, may provide such customization signals 644 to the one or more content providers 610 (or to the one or more dynamic customization systems 612) via the one or more customization inputs 652. In some implementations, the one or more customization signals 644 may include any of the types of signals described elsewhere herein, including one or more selection signals received from one or more input devices 441, active or passively acquired signals (e.g. obtained using sensors (e.g. infrared sensors, optical sensors, Wii® devices, Xbox Kinect® devices, Playstation® devices, etc.), or any other suitable types of signals.

In at least some implementations, the one or more sensors 650 may include one or more biomedical sensors 650 that passively or actively obtain signals based on biomedical conditions of the one or more users 640. For example, in some implementations, at least some of the one or more users 640 may wear one or more biomedical sensors 650 (e.g. arm cuffs, finger cuffs, ear pieces, headsets, patches, etc.) that sense, monitor, or detect conditions (e.g. pulse, blood pressure, breathing rate, breath duration, perspiration, pupil size, brain activity, electromagnetic emissions, electrochemical conditions, optical conditions, acoustic conditions, temperature, pressure, PH level, appearance, etc.) of the one or more users 640, and provide corresponding customization signals 644 to the one or more content providers 610 (or to the one or more dynamic customization systems 612) via the one or more customization inputs 652.

In further implementations, the one or more customization signals 644 may include or be determined based at least partially on information stored on (or communicated to or from) one or more electronic devices 446 (e.g. laptop, desktop, personal data assistant, personal digital assistant, cell phone, tablet, electronic reader, gaming device, communication device, navigational device, iPad®, iPhone®, iBook®, iWatch™, etc.) associated with at least some of the one or more users 640. For example, in at least some implementations, a memory 620 of an electronic device 446 (e.g. a cell phone, etc.) may include information that may be used to formulate one or more customization inputs 652 that may advantageously enhance a viewing experience or satisfaction of at least some of the one or more users 640 within the sensing area 660. As shown in FIG. 6, in at least some implementations, the memory 620 may include one or more photos 622, browsing data 624, purchase records 626, call records 628, navigation data 630 (e.g. GPS data, cell tower data, directions, Facebook® location data, etc.), communication data 632 (e.g. Twitter® data, texts, email, blogs, etc.), downloaded content 634 (e.g. music, movies, literature, etc.), or any other suitable information or data 636 (e.g. demographic data, profile data, etc.). Alternately, such information that may be used to formulate one or more customization inputs 652 need not be stored on the one or more electronic devices 446, but rather, such information may be communicated with (to or from) the one or more electronic devices 446.

In operation, the one or more core content providers 610 receive the one or more selection inputs 652 (or default inputs if specific inputs are not provided), and modify audio-visual content (either core content, advertising content, or both) using the one or more dynamic customization systems 612 to provide a dynamically customized audio-visual content 670 to a distribution device 672 (e.g. a display, a speaker, an output device, electronic paper, electronic billboard, earphones, laptop, table, etc.) accessible to the one or more users 640. In at least some embodiments, a consideration 690 (e.g. payment, privilege, data, etc.) may be provided from at least some of the one or more users 640 to the one or more content providers 610 in exchange for the dynamically customized audio-visual content 670. In further embodiments, the consideration 690 may be provided from the one or more content providers 610 to the one or more users 640, such as for research, audience testing, or any other suitable purpose.

Of course, other environments may be implemented to perform the dynamic customization of audio-visual content in accordance with the present disclosure, and systems in accordance with the present disclosure are not necessarily limited to the specific implementations shown and described herein. Additional functions and operational aspects of systems in accordance with the teachings of the present disclosure are described more fully below.

Exemplary Processes for Dynamic Customization and Monetization of Audio-Visual Content

In the following description of exemplary processes for dynamic-customization of audio-visual content, reference will be made to specific components of the exemplary systems described above and shown in FIGS. 1 through 6. It will be appreciated, however, that such references are merely exemplary, and that the inventive processes are not limited to being implemented on the specific systems described above, but rather, the processes described herein may be implemented on a wide variety of suitable systems and in a wide variety of suitable environments.

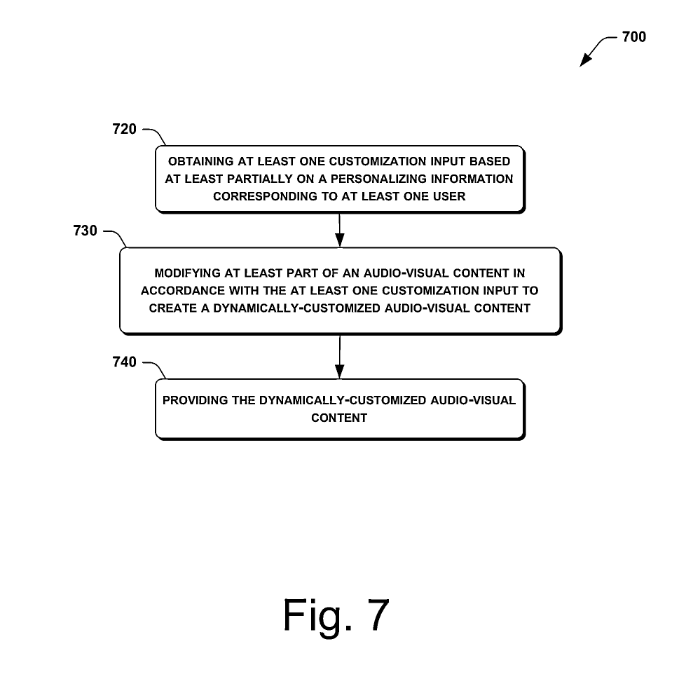

FIG. 7 shows a flowchart of a process 700 for dynamic-customization of audio-visual content in accordance with an implementation of the present disclosure. In this implementation, the process 700 includes obtaining at least one customization input based at least partially on a personalizing information corresponding to at least one user at 720, modifying at least part of an audio-visual content in accordance with the at least one customization input to create a dynamically customized audio-visual content at 730, and providing the dynamically-customized audio-visual content at 740.

It will be appreciated that in accordance with the present disclosure, an audio-visual content (e.g. an audio-visual core portion, an advertising content portion, other content portion, or combinations thereof) may be dynamically customized in accordance with a viewer's personalizing information (or preferences), thereby increasing the viewer's satisfaction. By means of the at least one customization input based at least partially on a personalizing information, the viewer (e.g. viewer 140, user 640, etc.) may indicate preferences for actresses (and actors) 132, vehicles 134, depicted products (or props) 135, environmental aspects 136 (e.g. buildings, scenery, setting, background, lighting, etc.), language 138, setting, background aspects, music, or a variety of other suitable preferences. In further implementations, virtually any desired aspect of the audio-visual content may be dynamically customized in accordance with the viewer's personalizing information, selections, preferences, or characteristics as implemented by one or more customization inputs 640.

A wide variety of different types of input may serve as the audio-visual content. For example, in some implementations, the audio-visual content may include a television broadcast (e.g. conventional wireless television broadcast, cable television broadcast, satellite television broadcast, etc.), an audio-visual data stream (e.g. streaming audio-visual content via Internet, audio-visual data stream via LAN, etc.), a separate audio portion and a separate video portion (e.g. receiving an audio signal via a wireless connection and receiving a video data stream via a cable or vice versa, receiving an audio signal via a first wireless connection and receiving a video signal via a second wireless connection, etc.), only an audio portion, or only a video portion.

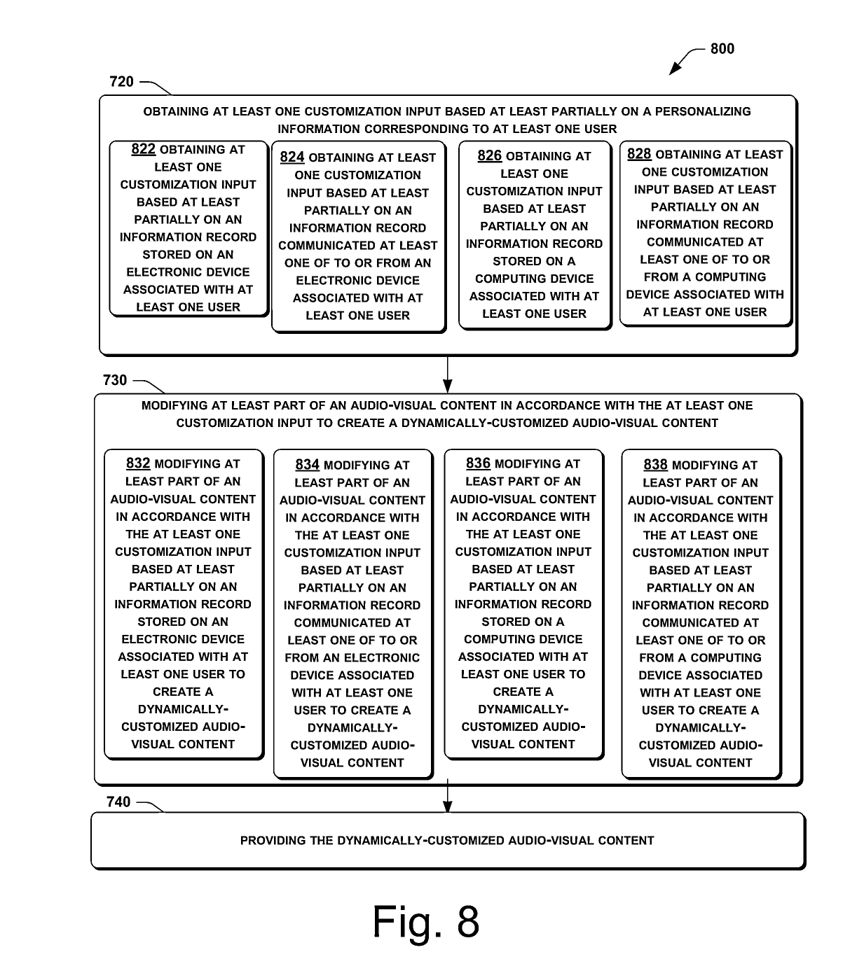

In accordance with the teachings of the present disclosure, a wide variety of customization inputs may be obtained for purposes of customizing audio-visual content. For example, as shown in FIG. 8, in some implementations, obtaining at least one customization input based at least partially on a personalizing information corresponding to at least one user at 720 may include obtaining at least one customization input based at least partially on an information record stored on an electronic device associated with at least one user at 822 (e.g. obtaining a customization input indicating a user is a child based on a parental control setting stored on a laptop computer associated with the user, obtaining a customization input indicating a user is a particular religious affiliation based on a newsletter transmitted to an electronic reader associated with a user, etc.). In other implementations, obtaining at least one customization input based at least partially on a personalizing information corresponding to at least one user at 720 may include obtaining at least one customization input based at least partially on an information record communicated at least one of to or from an electronic device associated with of at least one user at 824 (e.g. obtaining a customization input indicating a user speaks a particular language based on a language control setting stored on a computer associated with the user, obtaining a customization input indicating a user has an affinity for swimming events based on a Tweet transmitted from a communication device associated with a user, etc.).

In other implementations, obtaining at least one customization input based at least partially on a personalizing information corresponding to at least one user at 720 may include obtaining at least one customization input based at least partially on an information record stored on a computing device associated with at least one user at 826 (e.g. an information record stored on a laptop, tablet, desktop, etc.). In other implementations, obtaining at least one customization input based at least partially on a personalizing information corresponding to at least one user at 720 may include obtaining at least one customization input based at least partially on an information record communicated at least one of to or from a computing device associated with at least one user at 828 (e.g. an information record communicated with a laptop, tablet, desktop, etc.).

As further shown in FIG. 8, in some implementations, modifying at least part of an audio-visual content in accordance with the at least one customization input to create a dynamically customized audio-visual content at 730 may include modifying at least part of an audio-visual content in accordance with the at least one customization input based at least partially on an information record stored on an electronic device associated with at least one user to create a dynamically customized audio-visual content at 832 (e.g. modifying using a customization input based at least partially on an information record stored on or communicated with a laptop, tablet, desktop, etc.). In other implementations, modifying at least part of an audio-visual content in accordance with the at least one customization input to create a dynamically customized audio-visual content at 730 may include modifying at least part of an audio-visual content in accordance with the at least one customization input based at least partially on an information record communicated at least one of to or from an electronic device associated with at least one user to create a dynamically customized audio-visual content at 834 (e.g. modifying using a customization input based at least partially on an information record stored on or communicated with an e-reader, an electronic watch, a gaming device, etc.).

In other implementations, modifying at least part of an audio-visual content in accordance with the at least one customization input to create a dynamically customized audio-visual content at 730 may include modifying at least part of an audio-visual content in accordance with the at least one customization input based at least partially on an information record stored on a computing device associated with at least one user to create a dynamically customized audio-visual content at 836. In other implementations, modifying at least part of an audio-visual content in accordance with the at least one customization input to create a dynamically customized audio-visual content at 730 may include modifying at least part of an audio-visual content in accordance with the at least one customization input based at least partially on an information record communicated at least one of to or from a computing device associated with at least one user to create a dynamically customized audio-visual content at 838 (e.g. adjusting a shock value or a calming value of an audio-visual content in response to an information record stored on a health monitoring device indicating a possible sensitivity to shocking subject matter, etc.).

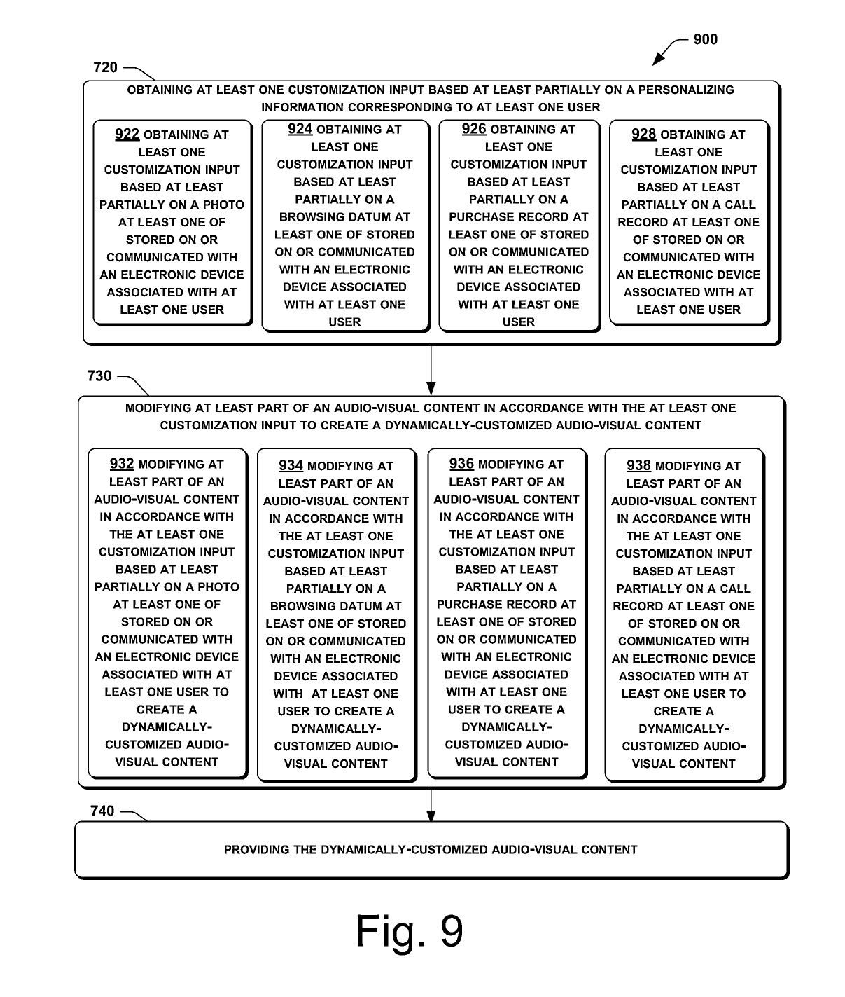

Similarly, as shown in FIG. 9, in some implementations, obtaining at least one customization input based at least partially on a personalizing information corresponding to at least one user at 720 may include obtaining at least one customization input based at least partially on a photo at least one of stored on or communicated with an electronic device associated with at least one user at 922 (e.g. obtaining a customization input indicating a change of setting of an advertisement to London based on a photo of London from a recent vacation stored on a user's cellular telephone, obtaining a customization input indicating a bird-watching customization based on photos of birds communicated with a user's computing device, etc.).

In other implementations, obtaining at least one customization input based at least partially on a personalizing information corresponding to at least one user at 720 may include obtaining at least one customization input based at least partially on a browsing dataum at least one of stored on or communicated with an electronic device associated with at least one user at 924 (e.g. obtaining a customization input indicating an advertisement having a soccer star based on a browsing history indicating an affinity for following soccer, obtaining a customization input providing for a particular actress based on an indication that a user follows a particular actress on Twitter based on tweets communicated with a user's communication device, etc.). In other implementations, obtaining at least one customization input based at least partially on a personalizing information corresponding to at least one user at 720 may include obtaining at least one customization input based at least partially on a purchase record at least one of stored on or communicated with an electronic device associated with at least one user at 926 (e.g. obtaining a customization input indicating including a Chevrolet automobile in a television segment based on a purchase record indicating a user recently purchased a Chevrolet, obtaining a customization input indicating to include a particular brand of clothing in a customized content based on a purchase record communicated with a user's cellular telephone, etc.). In other implementations, obtaining at least one customization input based at least partially on a personalizing information corresponding to at least one user at 720 may include obtaining at least one customization input based at least partially on a call record at least one of stored on or communicated with an electronic device associated with at least one user at 928 (e.g. obtaining a customization input indicating a commentator having a French accent based on a call records indicating a user recently had telephone communications with people in France, obtaining a customization input indicating an advertisement for Vonage® based on telephone records communicated with a user's cellular telephone indicating that the user obtains service from a competing telephone provider, etc.).

As further shown in FIG. 9, in some implementations, modifying at least part of an audio-visual content in accordance with the at least one customization input to create a dynamically customized audio-visual content at 730 may include modifying at least part of an audio-visual content in accordance with the at least one customization input based at least partially on a photo at least one of stored on or communicated with an electronic device associated with at least one user to create a dynamically customized audio-visual content at 932 (e.g. modifying a likeness of an actor in the movie The Terminator from Arnold Swarzenegger to Barack Obama based on locating a photo of Barack Obama on a user's iPad®, telephone, modifying a likeness of an actor in an advertisement to look like a user's grandfather based on locating a photo of the user's grandfather on a laptop, etc.). In other implementations, modifying at least part of an audio-visual content in accordance with the at least one customization input to create a dynamically customized audio-visual content at 730 may include modifying at least part of an audio-visual content in accordance with the at least one customization input based at least partially on a browsing datum at least one of stored on or communicated with an electronic device associated with at least one user to create a dynamically customized audio-visual content at 934 (e.g. modifying a background of an automobile advertisement to be set in the Grand Canyon based on a browsing history on a user's computing device indicating an interest in the Grand Canyon, modifying a theme of an advertisement away from a politically liberal theme to a politically conservative theme based on a browsing history that indicates a preference for political conservatism, etc.).

In other implementations, modifying at least part of an audio-visual content in accordance with the at least one customization input to create a dynamically customized audio-visual content at 730 may include modifying at least part of an audio-visual content in accordance with the at least one customization input based at least partially on a purchase record at least one of stored on or communicated with an electronic device associated with at least one user to create a dynamically customized audio-visual content at 936 (e.g. modifying a brand of beer ordered by an actor in a movie from a first brand to a second brand based on a purchase record indicating a user prefers the second brand, modifying a brand of soft drink depicted in a television segment based on a purchase record that indicates that a user purchased a competing brand and an advertiser wishes to promote an alternate brand to the user, etc.). In other implementations, modifying at least part of an audio-visual content in accordance with the at least one customization input to create a dynamically customized audio-visual content at 730 may include modifying at least part of an audio-visual content in accordance with the at least one customization input based at least partially on a call record at least one of stored on or communicated with an electronic device associated with at least one user to create a dynamically customized audio-visual content at 938 (e.g. modifying an advertisement to promote improved long distance rates by a first brand over a second brand based on a phone record that indicates the user has called long distance using the second brand of phone carrier, modifying a content to show a user using a speaker phone over a non-speaker phone based on an indication of a user's preference for speaker phone usage, etc.).

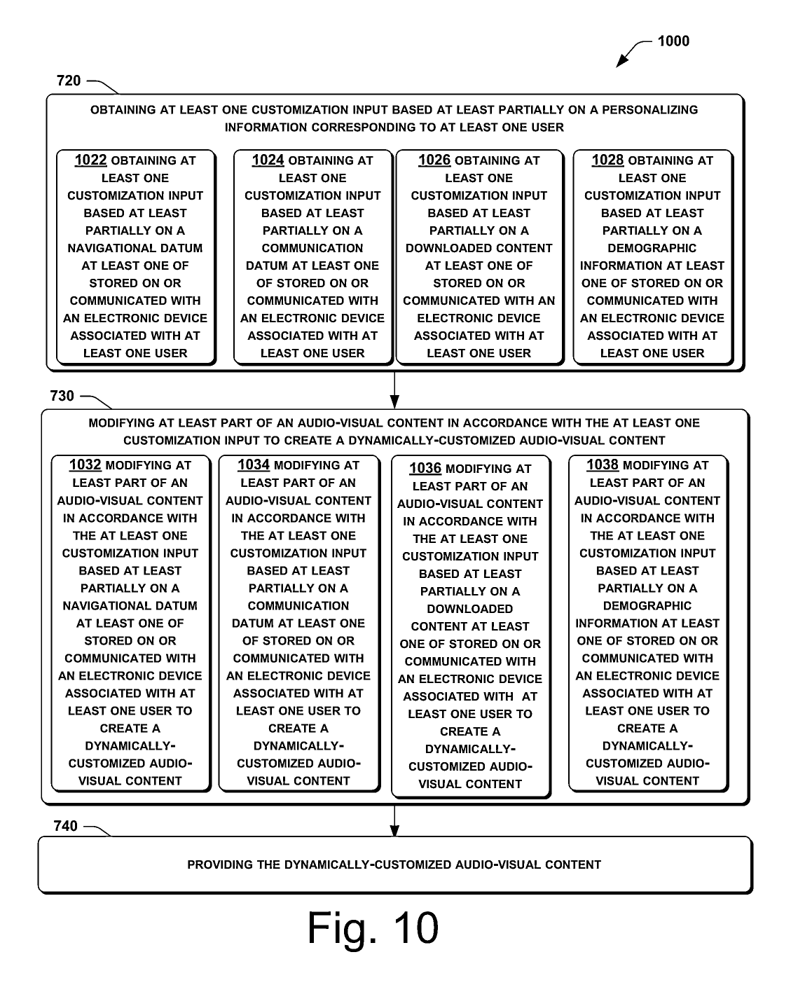

In addition, as shown in FIG. 10, in some implementations, obtaining at least one customization input based at least partially on a personalizing information corresponding to at least one user at 720 may include obtaining at least one customization input based at least partially on a navigational datum at least one of stored on or communicated with an electronic device associated with at least one user at 1022 (e.g. obtaining a customization input indicating a cityscape background rather than a country side background based on navigational data indicating recent travel to a city, obtaining a customization input indicating a Southern accent rather than a Northern accent based on GPS data indicating a primary location of the user in the South, etc.). In other implementations, obtaining at least one customization input based at least partially on a personalizing information corresponding to at least one user at 720 may include obtaining at least one customization input based at least partially on a communication datum at least one of stored on or communicated with an electronic device associated with at least one user at 1024 (e.g. obtaining a customization input indicating a preference for a comedian spokesperson over a sports-figure spokesperson based on record indicating a user follows comedians on Twitter rather than sports figures, obtaining a customization input indicating a preference for a female spokesperson over a male spokesperson based on a greater number of electronic communications with women compared with men, etc.).

In other implementations, obtaining at least one customization input based at least partially on a personalizing information corresponding to at least one user at 720 may include obtaining at least one customization input based at least partially on a downloaded content at least one or stored on or communicated with an electronic device associated with at least one user at 1026 (e.g. obtaining a customization input indicating a preference for hunting advertisements over clothing advertisements based on a greater number of hunting-related articles over clothing-related articles, obtaining a customization input indicating a preference for child-related products over other products based on a greater number of articles pertaining to child-related topics, etc.). In other implementations, obtaining at least one customization input based at least partially on a personalizing information corresponding to at least one user at 720 may include obtaining at least one customization input based at least partially on a demographic information at least one of stored on or communicated with an electronic device associated with at least one user at 1028 (e.g. obtaining a customization input indicating a preference for female-oriented products over male-oriented products based on a demographic indicator that Facebook® profile stored on a user's cellular phone indicating a user is female, obtaining a customization input indicating a preference for rural-themed content over urban-themed content based on an address record indicating a user is located in a rural area, etc.).

As further shown in FIG. 10, in some implementations, modifying at least part of an audio-visual content in accordance with the at least one customization input to create a dynamically customized audio-visual content at 730 may include modifying at least part of an audio-visual content in accordance with the at least one customization input based at least partially on a navigational datum at least one of stored on or communicated with an electronic device associated with at least one user to create a dynamically customized audio-visual content at 1032 (e.g. modifying an advertisement to depict an automobile being driven on a beach rather than along a mountain road based on navigational data indicating recent travel to a beach, modifying a digital data stream to advertise a watercraft rather than an automobile based on GPS data indicating recent travel aboard a cruise ship, etc.). In other implementations, modifying at least part of an audio-visual content in accordance with the at least one customization input to create a dynamically customized audio-visual content at 730 may include modifying at least part of an audio-visual content in accordance with the at least one customization input based at least partially on a communication datum at least one of stored on or communicated with an electronic device associated with at least one user to create a dynamically customized audio-visual content at 1034 (e.g. modifying an advertisement to depict a first product rather than a second product based on a blog entry “liked” by a user that describes the first product, modifying a commercial spokesperson to a well-known sports figure from a user's alma mater based on a communication indicating an affinity for the user's alma mater, etc.).

In other implementations, modifying at least part of an audio-visual content in accordance with the at least one customization input to create a dynamically customized audio-visual content at 730 may include modifying at least part of an audio-visual content in accordance with the at least one customization input based at least partially a downloaded content at least one of stored on or communicated with an electronic device associated with at least one user to create a dynamically customized audio-visual content at 1036 (e.g. modifying an advertisement to depict cameras rather than sewing machines based on downloaded content on a user's computer indicating recent shopping for cameras, modifying a television segment to include a dolphin rather than a buffalo based on downloaded content indicating recent research into dolphins, etc.). In other implementations, modifying at least part of an audio-visual content in accordance with the at least one customization input to create a dynamically customized audio-visual content at 730 may include modifying at least part of an audio-visual content in accordance with the at least one customization input based at least partially on a demographic information at least one of stored on or communicated with an electronic device associated with at least one user to create a dynamically customized audio-visual content at 1038 (e.g. modifying an advertisement to include language more suitable for a young generation based on an indicator of a user's young age, modifying a television segment to provide more scientifically detailed content based on an indicator of a user's profession in a scientifically-oriented field, etc.).

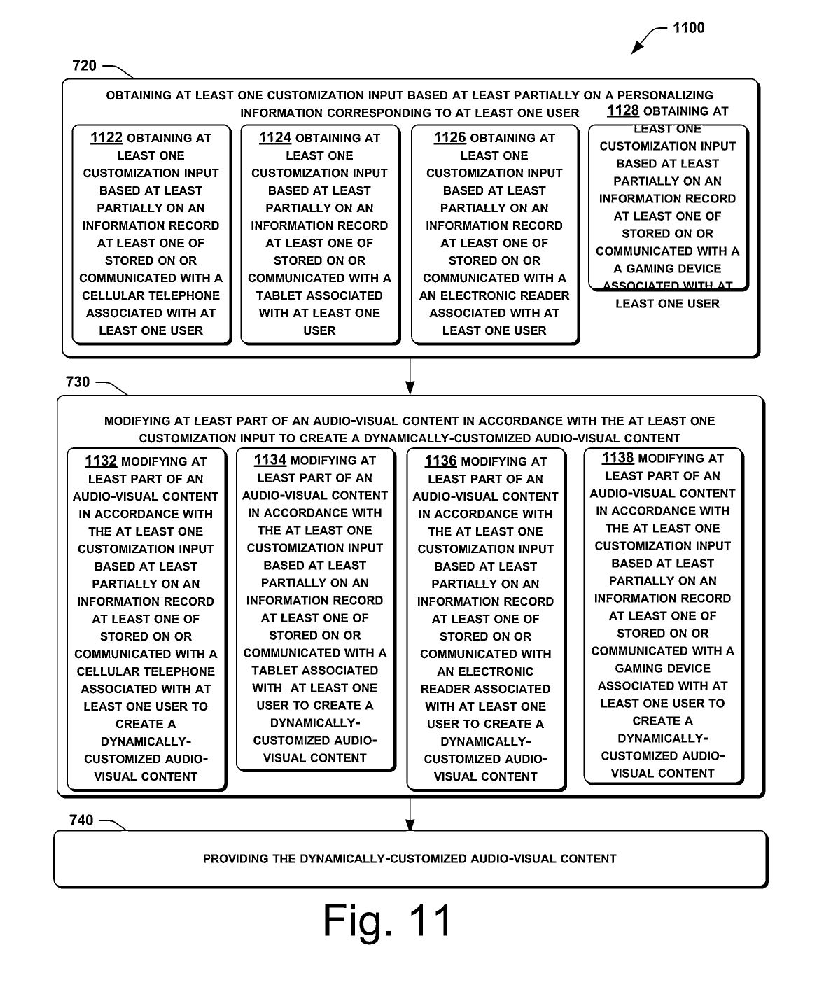

Further, as shown in FIG. 11, in some implementations, obtaining at least one customization input based at least partially on a personalizing information corresponding to at least one user at 720 may include obtaining at least one customization input based at least partially on an information record at least one of stored on or communicated with a cellular telephone associated with at least one user at 1122 (e.g. obtaining a customization input based at least partially on a text message, Tweet, a voice mail message, etc.). In other implementations, obtaining at least one customization input based at least partially on a personalizing information corresponding to at least one user at 720 may include obtaining at least one customization input based at least partially on an information record at least one of stored on or communicated with a tablet associated with at least one user at 1124 (e.g. obtaining a customization input based at least partially on an email message, etc.). In other implementations, obtaining at least one customization input based at least partially on a personalizing information corresponding to at least one user at 720 may include obtaining at least one customization input based at least partially on an information record at least one of stored on or communicated with an electronic reader associated with at least one user at 1126 (e.g. obtaining a customization input based at least partially on an electronic book, electronic article, etc.). In other implementations, obtaining at least one customization input based at least partially on a personalizing information corresponding to at least one user at 720 may include obtaining at least one customization input based at least partially on an information record at least one of stored on or communicated with a gaming device associated with at least one user at 1128 (e.g. obtaining a customization input based at least partially on a video game, a written message, a voice message, a game selection, etc.).

As further shown in FIG. 11, in some implementations, modifying at least part of an audio-visual content in accordance with the at least one customization input to create a dynamically customized audio-visual content at 730 may include modifying at least part of an audio-visual content in accordance with the at least one customization input based at least partially on an information record at least one of stored on or communicated with a cellular telephone associated with at least one user to create a dynamically customized audio-visual content at 1132 (e.g. modifying content according to a customization input based at least partially on a text message, Tweet, a voice mail message, etc.). In other implementations, modifying at least part of an audio-visual content in accordance with the at least one customization input to create a dynamically customized audio-visual content at 730 may include modifying at least part of an audio-visual content in accordance with the at least one customization input based at least partially on an information record at least one of stored on or communicated with a tablet associated with at least one user to create a dynamically customized audio-visual content at 1134 (e.g. modifying content according to a customization input based at least partially on an email message, etc.).

In other implementations, modifying at least part of an audio-visual content in accordance with the at least one customization input to create a dynamically customized audio-visual content at 730 may include modifying at least part of an audio-visual content in accordance with the at least one customization input based at least partially on an information record at least one of stored on or communicated with an electronic reader associated with at least one user to create a dynamically customized audio-visual content at 1136 (e.g. modifying content according to a customization input based at least partially on an electronic book, electronic article, etc.). In other implementations, modifying at least part of an audio-visual content in accordance with the at least one customization input to create a dynamically customized audio-visual content at 730 may include modifying at least part of an audio-visual content in accordance with the at least one customization input based at least partially on an information record at least one of stored on or communicated with a gaming device associated with at least one user to create a dynamically customized audio-visual content at 1138 (e.g. modifying content according to a customization input based at least partially on a video game, a written message, a voice message, a game selection, etc.).

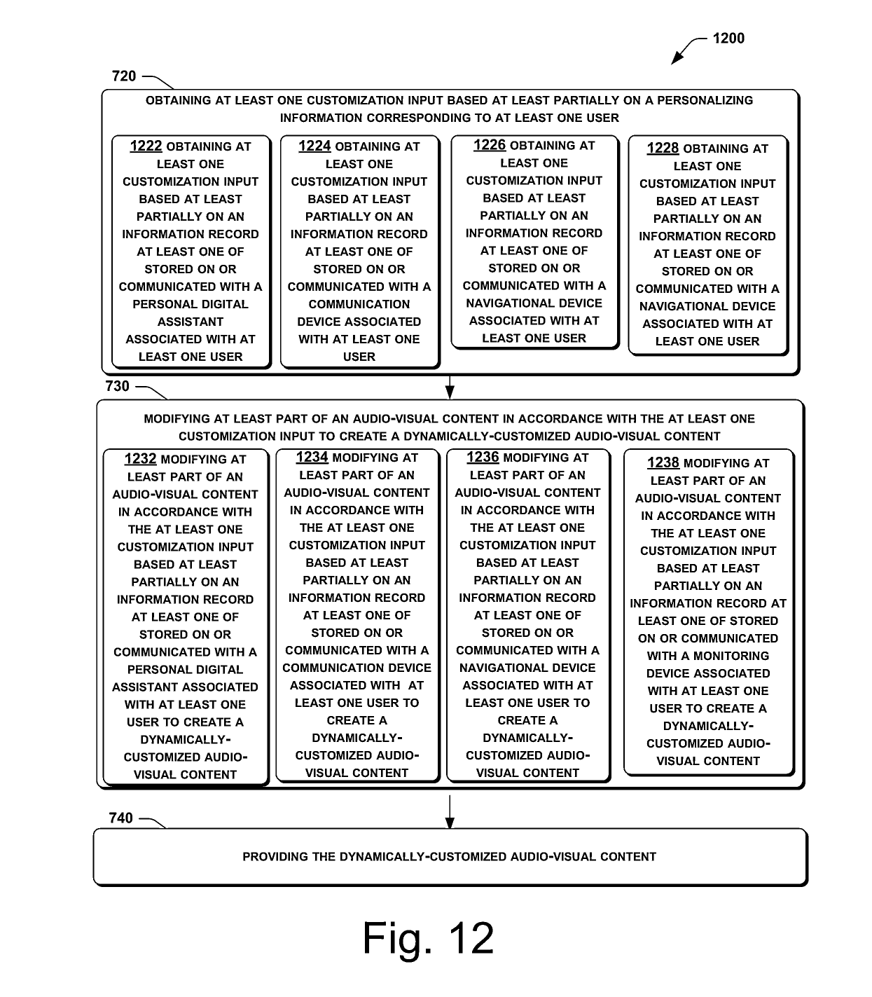

Similarly, as shown in FIG. 12, in some implementations, obtaining at least one customization input based at least partially on a personalizing information corresponding to at least one user at 720 may include obtaining at least one customization input based at least partially on an information record at least one of stored on or communicated with a personal digital assistant associated with at least one user at 1222 (e.g. obtaining a customization input based at least partially on a text message, a calendar entry, an RSS (Rich Site Summary) feed, etc.). In other implementations, obtaining at least one customization input based at least partially on a personalizing information corresponding to at least one user at 720 may include obtaining at least one customization input based at least partially on an information record at least one of stored on or communicated with a communication device associated with at least one user at 1224 (e.g. obtaining a customization input based at least partially on a text message, a voice mail message, an email, a Facebook® post, a Twitter® post, etc.).

In other implementations, obtaining at least one customization input based at least partially on a personalizing information corresponding to at least one user at 720 may include obtaining at least one customization input based at least partially on an information record at least one of stored on or communicated with a navigational device associated with at least one user at 1226 (e.g. obtaining a customization input based on position information, driving direction information, route information, stored destinations, stored routes, route preferences, etc.). In other implementations, obtaining at least one customization input based at least partially on a personalizing information corresponding to at least one user at 720 may include obtaining at least one customization input based at least partially on an information record at least one of stored on or communicated with a monitoring device associated with at least one user at 1228 (e.g. obtaining a customization input based on health monitoring information, ankle bracelet information, locator communications, emergency transmitter information, etc.).

As further shown in FIG. 12, in some implementations, modifying at least part of an audio-visual content in accordance with the at least one customization input to create a dynamically customized audio-visual content at 730 may include modifying at least part of an audio-visual content in accordance with the at least one customization input based at least partially on an information record at least one of stored on or communicated with a personal digital assistant associated with at least one user to create a dynamically customized audio-visual content at 1232 (e.g. modifying an advertisement to advertise bankruptcy services based on a stock market news feed indicating a downward stock market trend, modifying an advertisement to advertise flower deliver services based on a calendar entry indicating an upcoming wedding anniversary date, etc.). In other implementations, modifying at least part of an audio-visual content in accordance with the at least one customization input to create a dynamically customized audio-visual content at 730 may include modifying at least part of an audio-visual content in accordance with the at least one customization input based at least partially on an information record at least one of stored on or communicated with a communication device associated with at least one user to create a dynamically customized audio-visual content at 1234 (e.g. modifying a comedic content of a television segment in accordance with a customization input based on recent messages indicating a user needs cheering up, modifying a romantic content of an advertisement based on texts indicating a user is entering a relationship, etc.).

In other implementations, modifying at least part of an audio-visual content in accordance with the at least one customization input to create a dynamically customized audio-visual content at 730 may include modifying at least part of an audio-visual content in accordance with the at least one customization input based at least partially on an information record at least one of stored on or communicated with a navigational device associated with at least one user to create a dynamically customized audio-visual content at 1236 (e.g. modifying a content to reflect a Texas accent in accordance with a customization input indicating a recent trip to the Alamo, modifying an advertisement to advertise boots in accordance with a customization input indicating a recent trip to Greenland, etc.). In other implementations, modifying at least part of an audio-visual content in accordance with the at least one customization input to create a dynamically customized audio-visual content at 730 may include modifying at least part of an audio-visual content in accordance with the at least one customization input based at least partially on an information record at least one of stored on or communicated with a monitoring device associated with at least one user to create a dynamically customized audio-visual content at 1238 (e.g. modifying a horror value of a content in accordance with a customization input indicating a user may have a weak heart, modifying an advertisement to advertise a local bail bondsman based on position monitoring information indicating a wearer of an ankle bracelet has ventured beyond permissible boundaries, etc.).

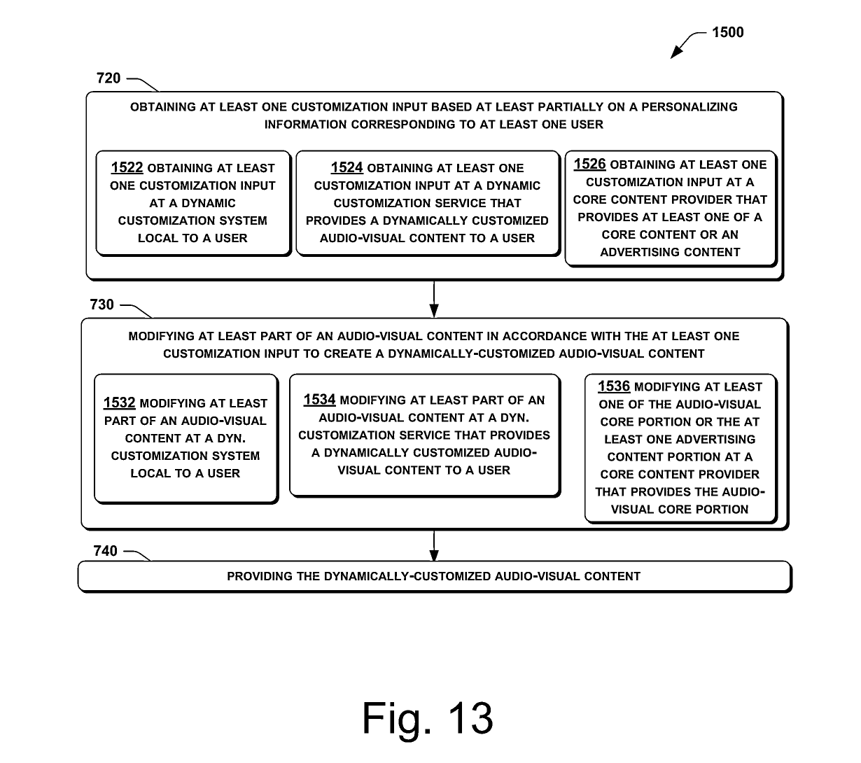

As shown in FIG. 13, in some implementations, obtaining at least one customization input based at least partially on a personalizing information corresponding to at least one user at 720 may include obtaining at least customization input at a dynamic customization system proximate to a user at 1522 (e.g. dynamic customization system 100 shown in FIG. 1, an Xbox®, Playstation®, Wii®, personal computer, Mac®, or other suitable processing device located within a viewer's living space or sphere of influence, etc.). In further implementations, obtaining at least one customization input based at least partially on a personalizing information corresponding to at least one user at 720 may include obtaining at least one customization input at a dynamic customization service that provides a dynamically customized audio-visual content to a user at 1524 (e.g. customization service provider 420 shown in FIG. 4). In still further implementations, obtaining at least one customization input based at least partially on a personalizing information corresponding to at least one user at 720 may include obtaining at least one customization input at a content provider that provides at least one of a core content or an advertising content at 1526 (e.g. core content provider 510 shown in FIG. 5).

As further shown in FIG. 13, in other implementations, modifying at least part of an audio-visual content in accordance with the at least one customization input to create a dynamically customized audio-visual content at 730 may include modifying at least part of an audio-visual content at a dynamic customization system proximate to a user at 1532 (e.g. dynamic customization system 100 shown in FIG. 1). In further implementations, modifying at least part of an audio-visual content in accordance with the at least one customization input to create a dynamically customized audio-visual content at 730 may include modifying at least part of an audio-visual content at a dynamic customization service that provides a dynamically customized audio-visual content to a user at 1534 (e.g. customization service provider 420 shown in FIG. 4). In still further implementations, modifying at least part of an audio-visual content in accordance with the at least one customization input to create a dynamically customized audio-visual content at 730 may include modifying at least part of an audio-visual content at a content provider that provides at least one of a core content or an advertising content at 1536 (e.g. core content provider 510 shown in FIG. 5).

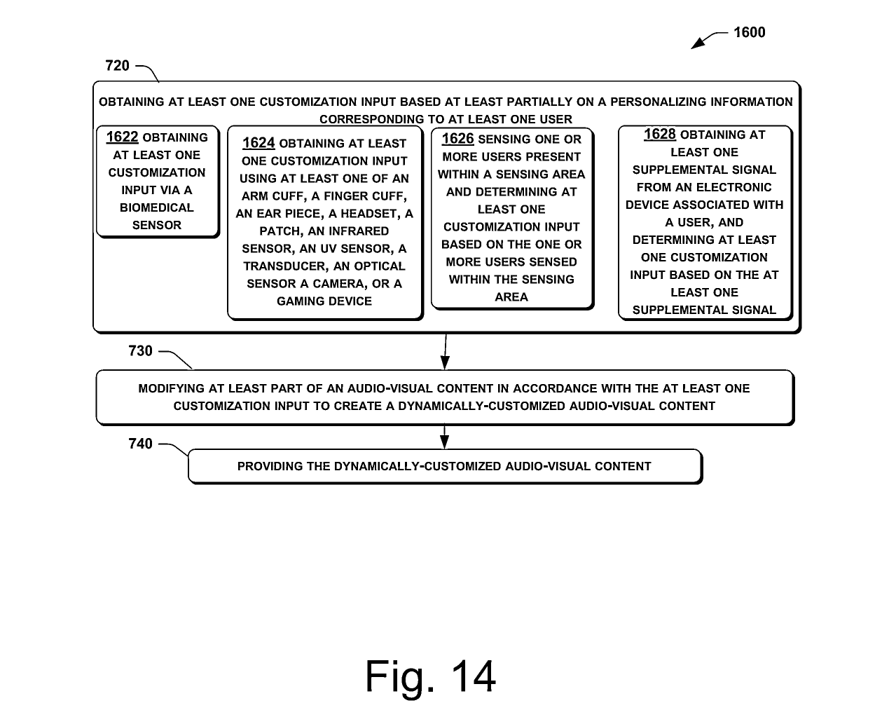

As shown in FIG. 14, in some implementations, in some implementations, obtaining at least one customization input based at least partially on a personalizing information corresponding to at least one user at 720 may include obtaining at least customization input via a biomedical sensor at 1622. In further implementations, obtaining at least one customization input based at least partially on a personalizing information corresponding to at least one user at 720 may include obtaining at least customization input using at least one of an arm cuff, a finger cuff, an ear piece, a headset, a patch, an infrared sensor, an ultraviolet sensor, a transducer, an optical sensor, a camera, or a gaming device at 1624. In still further implementations, obtaining at least one customization input based at least partially on a personalizing information corresponding to at least one user at 720 may include sensing one or more users present within a sensing area and determining at least one customization input based on the one or more users sensed within the sensing area at 1626 (e.g. sensing a parent and a child within a television viewing area, and determining a first customization input based on the parent and a second customization input based on the child, sensing a female and a male within a television viewing area, and determining customization input based on at least one of the female or the male, etc.). In other implementations, obtaining at least one customization input based at least partially on a personalizing information corresponding to at least one user at 720 may include obtaining at least one supplemental signal from an electronic device associated with a user (e.g. a cell phone, personal data assistant, laptop computer, desktop computer, smart phone, tablet, Apple iPhone, Apple iPad, Microsoft Surface, Kindle Fire, etc.) and determining at least one customization input based on the at least one supplemental signal at 1628.

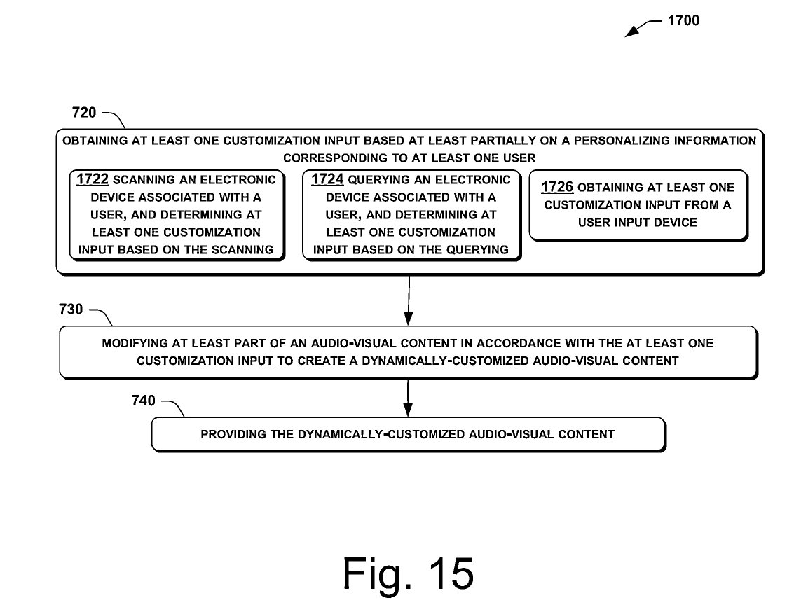

As shown in FIG. 15, in other implementations, obtaining at least one customization input based at least partially on a personalizing information corresponding to at least one user at 720 may include scanning an electronic device associated with a user (e.g. a cell phone, personal data assistant, laptop computer, desktop computer, smart phone, tablet, Apple iPhone®, Apple iPad®, Microsoft Surface®, Kindle Fire®, etc.) and determining at least one customization signal based on the scanning at 1722. And in other implementations, obtaining at least one customization input based at least partially on a personalizing information corresponding to at least one user at 720 may include querying an electronic device associated with a user (e.g. a cell phone, personal data assistant, laptop computer, desktop computer, smart phone, tablet, Apple iPhone®, Apple iPad®, Microsoft Surface®, Kindle Fire®, etc.) and determining at least one selection signal based on the querying at 1724. In further implementations, obtaining at least one customization input based at least partially on a personalizing information corresponding to at least one user at 720 may include obtaining at least one customization input from a user input device at 1726.

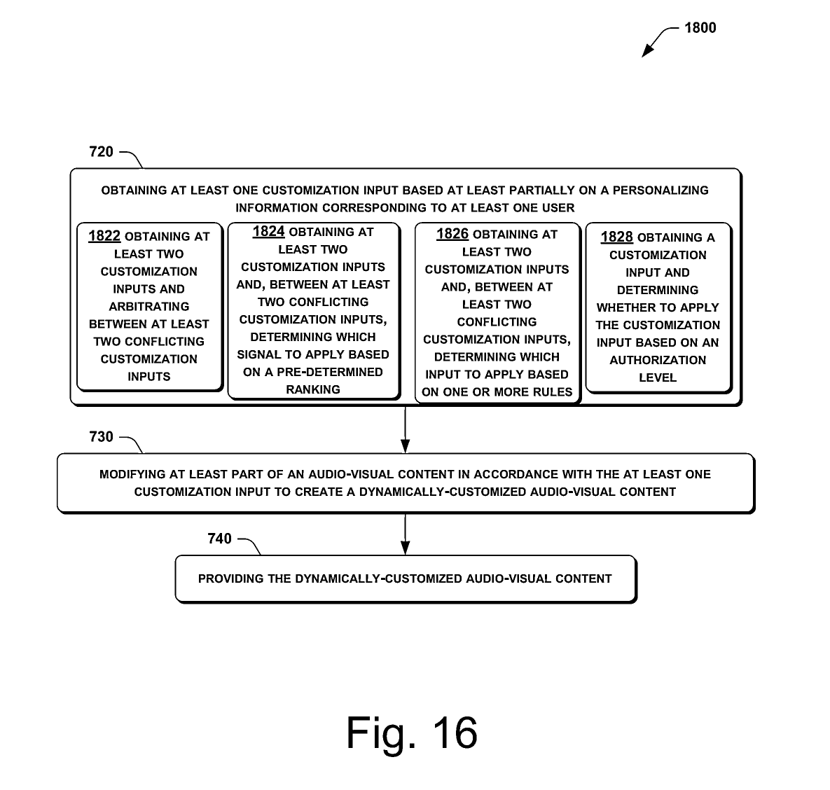

In some instances, one or more customization inputs may conflict with one or more other customization inputs. Such conflicts may be resolved in a variety of suitable ways. For example, as shown in FIG. 16, in some implementations, obtaining at least one customization input based at least partially on a personalizing information corresponding to at least one user at 720 may include obtaining at least two customization inputs, and arbitrating between at least two conflicting customization inputs at 1822 (e.g. receiving a first customization input indicating a desire to view R-rated subject matter, and a second customization input indicating that a child is in the viewing area, and arbitrating between the first and second customization inputs such that the R-rated subject matter is not shown). In at least some implementations, obtaining at least one customization input based at least partially on a personalizing information corresponding to at least one user at 720 may include obtaining at least two customization inputs, and between at least two conflicting customization inputs, determining which input to apply based on a pre-determined ranking at 1824 (e.g. receiving a first customization input from a manual input device to view a movie in English and a second customization input from a scanning of a laptop computer indicating a preference for French, and determining to apply the first customization input based on a pre-determined ranking that gives higher ranking to manually input signals over signals determined by scanning; receiving a first customization input from a parent's electronic device and a second customization input from a child's electronic device, and determining to apply the first customization input based on a ranking that gives priority to signals from the parent's electronic device over the child's electronic device, etc.).

In further implementations, obtaining at least one customization input based at least partially on a personalizing information corresponding to at least one user at 620 may include obtaining at least two customization inputs, and between at least two conflicting customization inputs, determining which signal to apply based on one or more rules at 1826 (e.g. receiving a first customization input from a manual input device indicating a desire to maintain a lower shock rating, and a second customization input from a biomedical sensor indicating a higher shock rating, and determining not to increase a shock value of the audio-visual content based on a rule that give priority to manual inputs over inputs from biomedical sensors, etc.). In still other implementations, obtaining at least one customization input based at least partially on a personalizing information corresponding to at least one user at 620 may include obtaining a customization input, and determining whether to apply the customization input based on an authorization level at 1828 (e.g. receiving a customization input from a biomedical sensor indicating a desire to view R-rated content, and determining not to display the R-rated content based on a lack of authorization).

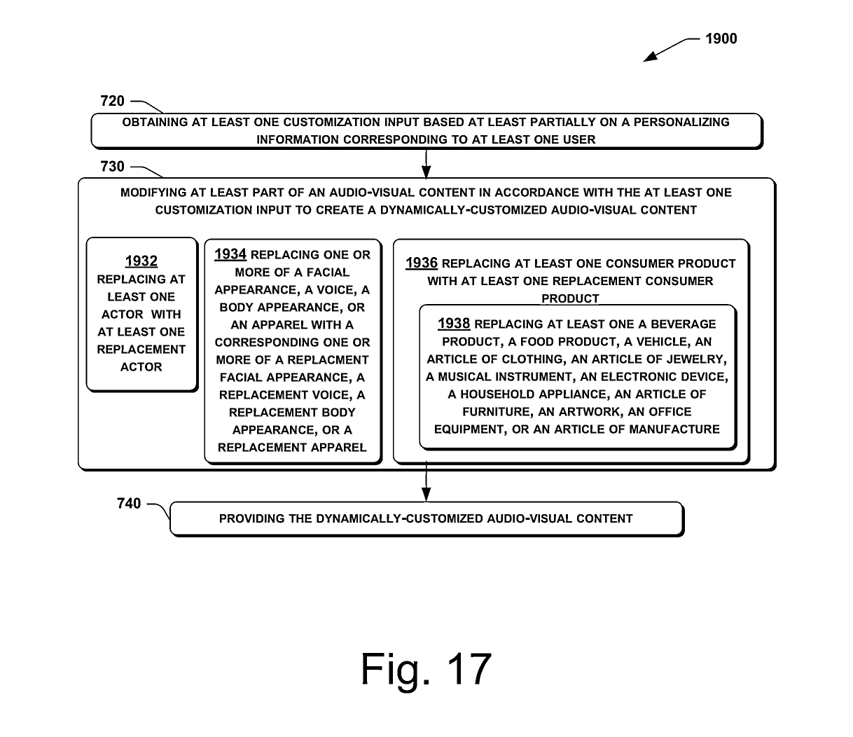

As noted above, a wide variety of aspects of at least one of the audio-visual core portion or the at least one advertising content portion may be dynamically customized in accordance with the preferences of a viewer. For example, as shown in FIG. 17, in at least some implementations, modifying at least part of an audio-visual content in accordance with the at least one customization input to create a dynamically customized audio-visual content at 730 may include replacing at least one actor with at least one replacement actor at 1932 (e.g. replacing the actor Brad Pitt in the movie Troy with replacement actor Mel Gibson, replacing the actor Meryl Streep in an advertisement with Jessica Alba, the term “actor” being used herein a gender-neutral manner to include both males and females, etc.).

In further implementations, modifying at least part of an audio-visual content in accordance with the at least one customization input to create a dynamically customized audio-visual content at 730 may include replacing one or more of a facial appearance, a voice, a body appearance, or an apparel with a corresponding one or more of a replacement facial appearance, a replacement voice, a replacement body appearance, or a replacement apparel at 1934 (e.g. replacing a facial appearance and a voice of the actor Brad Pitt in an advertisement with a replacement facial appearance of actor Mel Gibson and a replacement voice of actor Chris Rock, replacing a body appearance and an apparel of actor Meryl Streep in the movie The Manchurian Candidate with a replacement body appearance of actor Jessica Alba and a replacement apparel based on a browsing history of online clothing shopping recently viewed by the viewer as indicated by supplemental signals from the viewer's laptop computer, etc.).

As further shown in FIG. 17, in still other implementations, modifying at least part of an audio-visual content in accordance with the at least one customization input to create a dynamically customized audio-visual content at 730 may include replacing at least one consumer product with at least one replacement consumer product at 1936 (e.g. replacing a can of Coke® held by an actor in a television sitcom with a can of Dr. Pepper®, replacing a hamburger eaten by a character in an advertisement with a taco, replacing a Gibson® guitar played by a character in a podcast with a Fender® guitar, etc.). In further implementations, replacing at least one consumer product with at least one replacement consumer product at 1936 may include replacing at least one of a beverage product, a food product, a vehicle, an article of clothing, an article of jewelry, a musical instrument, an electronic device, a household appliance, an article of furniture, an artwork, an office equipment, or an article of manufacture at 1938.

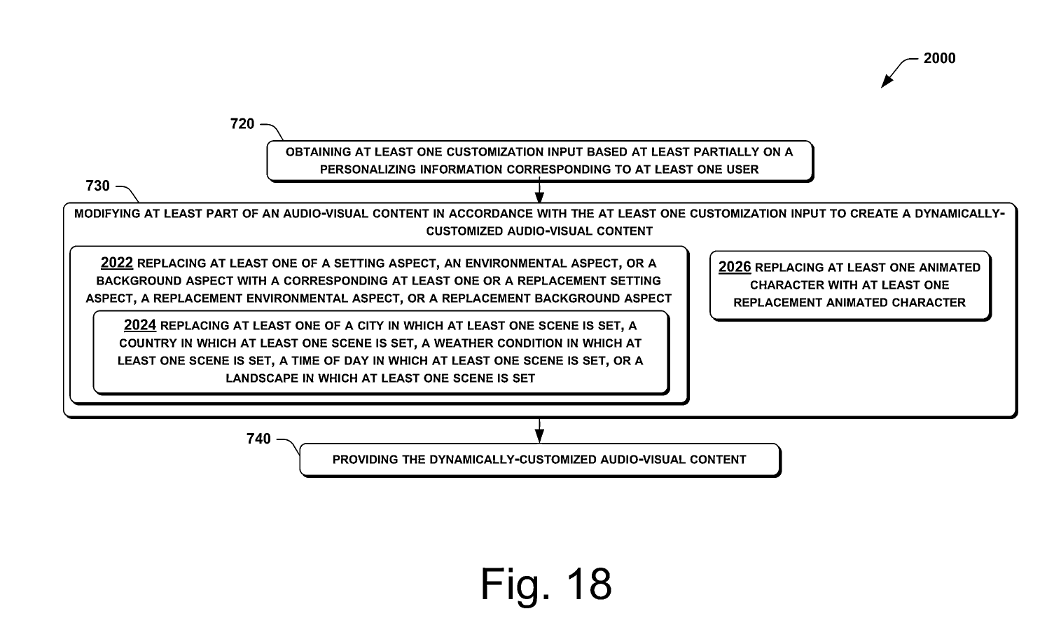

Referring now to FIG. 18, in additional implementations, modifying at least part of an audio-visual content in accordance with the at least one customization input to create a dynamically customized audio-visual content at 730 may include replacing at least one of a setting aspect, an environmental aspect, or a background aspect of the audio-visual core portion with a corresponding at least one of a replacement setting aspect, a replacement environmental aspect, or a replacement background aspect at 2022. For example, one or more scenes from a movie may be set in a different location (e.g. scenes from Sleepless in Seattle may be set in Cleveland, or a background with the Golden Gate bridge may be replaced with the Tower Bridge over the Thames River, etc.). Alternately, a weather condition may be replaced with a different weather condition (e.g. a surfing scene from Baywatch may take place in a snowstorm instead of a sunny day, etc.), or buildings in a background may be replaced with mountains or open countryside.

In some implementations, replacing at least one of a setting aspect, an environmental aspect, or a background aspect of the audio-visual core portion with a corresponding at least one of a replacement setting aspect, a replacement environmental aspect, or a replacement background aspect at 2022 may include replacing at least one of a city in which at least one scene is set, a country in which at least one scene is set, a weather condition in which at least one scene is set, a time of day in which at least one scene is set, or a landscape in which at least one scene is set at 2024.

As further shown in FIG. 18, in other implementations, modifying at least part of an audio-visual content in accordance with the at least one customization input to create a dynamically customized audio-visual content at 730 may include replacing at least one animated character with at least one replacement animated character at 2026 (e.g. replacing a cartoon Snow White from Snow White and the Seven Dwarfs with a cartoon Alice from Alice in Wonderland, replacing an animated elf with an animated dwarf, etc.).

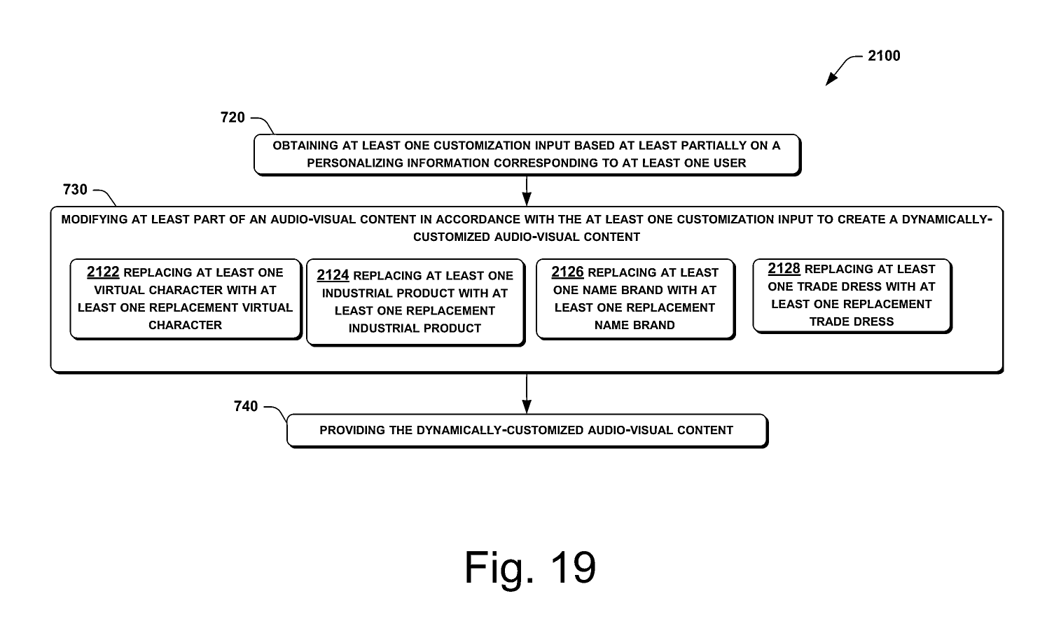

With reference to FIG. 19, in further implementations, modifying at least part of an audio-visual content in accordance with the at least one customization input to create a dynamically customized audio-visual content at 730 may include replacing at least one virtual character with at least one replacement virtual character at 2122 (e.g. replacing a virtual warrior with a virtual wizard, etc.). In still other implementations, modifying at least part of an audio-visual content in accordance with the at least one customization input to create a dynamically customized audio-visual content at 730 may include replacing at least one industrial product depicted in the audio-visual core portion with at least one replacement industrial product at 2124 (e.g. replacing a nameplace on a milling machine from “Cincinnati” to “Bridgeport” in a factory scene, replacing a name of a shipping line and/or the colors on a container ship from “Maersk” to “Evergreen,” etc.).

In still further implementations, modifying at least part of an audio-visual content in accordance with the at least one customization input to create a dynamically customized audio-visual content at 730 may include replacing at least one name brand with at least one replacement name brand at 2126 (e.g. replacing a leather label on character's pants from “Levis” to “J Brand,” replacing an Izod alligator on a character's shirt with a Ralph Lauren horse logo, replacing a shoe logo from “Gucci” to “Calvin Klein,” etc.). In yet other implementations, modifying at least part of an audio-visual content in accordance with the at least one customization input to create a dynamically customized audio-visual content at 730 may include replacing at least one trade dress with at least one replacement trade dress at 2128 (e.g. replacing uniforms, packaging, colors, signs, logos, and any other items associated with a trade dress of “McDonald's” restaurant with corresponding trade dress items associated with “Burger King” restaurant, replacing brown trucks and uniforms associated with the “UPS” delivery company with red and yellow trucks and uniforms associated with the “DHL Express” delivery company, replacing helmets and jerseys associated with the Minnesota Vikings with replacement helmets and jerseys associated with the Seattle Seahawks, etc.).

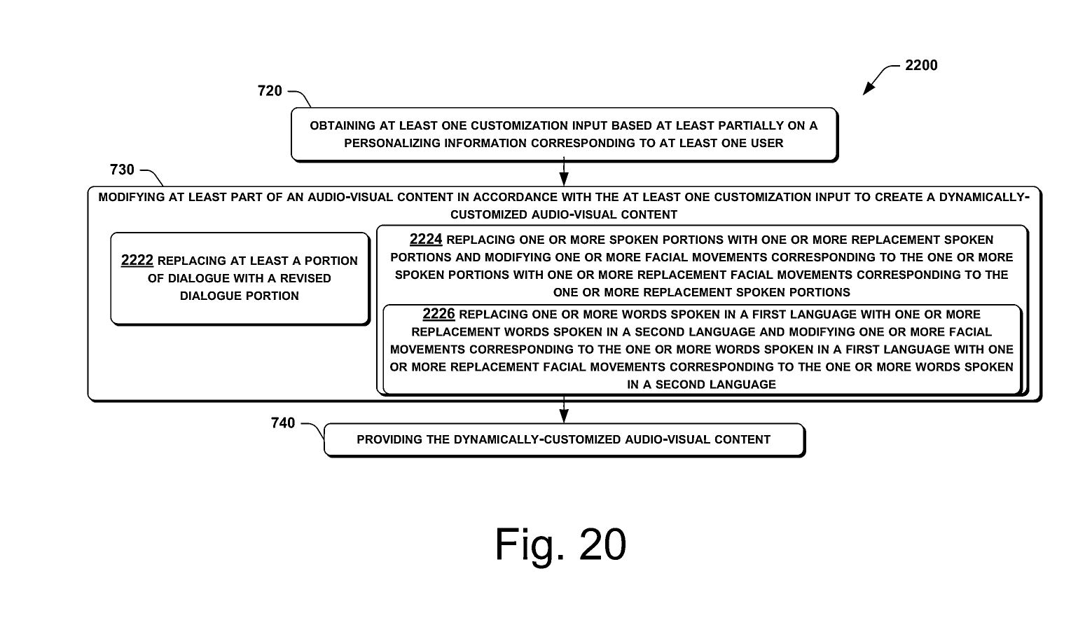

Additional possible implementations of modifying at least part of an audio-visual content in accordance with the at least one customization input to create a dynamically customized audio-visual content at 730 are shown in FIG. 20. For example, in some implementations, modifying at least part of an audio-visual content in accordance with the at least one customization input to create a dynamically customized audio-visual content at 730 may include replacing at least a portion of dialogue with a revised dialogue portion at 2222. For example, based on the at least one customization input (e.g. a detecting of a biomedical condition indicating an aversion to profanity, etc.), a portion of dialogue of a movie that contains profanity or that may otherwise be offensive to the viewer is replaced with a replacement portion of dialogue that is not offensive to the viewer (e.g. a dialogue of a movie is modified from an R-rated dialogue to a lower-rated dialogue, such as PG-13-rated dialogue or a G-rated dialogue, such as “Frankly, my dear, I don't give a damn” being replaced with “Frankly, my dear, I don't really care”, a dialogue that is threatening or violent may be replaced with a less-threatening or less-violent dialogue, etc.).

In some implementations, modifying at least part of an audio-visual content in accordance with the at least one customization input to create a dynamically customized audio-visual content at 730 may include replacing one or more spoken portions with one or more replacement spoken portions (e.g. replacing a profane word, such as “damn,” with a non-profane word, such as “darn,” replacing a first laughter, such as a “tee hee hee,” with a second laugher, such as a “ha ha ha,” etc.) and modifying one or more facial movements corresponding to the one or more spoken portions with one or more replacement facial movements corresponding to the one or more replacement spoken portions (e.g. replacing one or more lip movements corresponding with the profane word with one or more replacement lip movements corresponding with the non-profane word, replacing lip and eye movements corresponding with the first laughter with replacement lip and eye movements corresponding with the second laughter, etc.) at 2224. Accordingly, unlike conventional editing practices that change spoken words but leave facial movements unchanged, in accordance with at least some implementations, by replacing both the audible portions and the corresponding facial movements, it is not apparent to a viewer that any changes have been made to the dialogue of the audio-visual core portion.

As further shown in FIG. 20, in further implementations, replacing one or more spoken portions with one or more replacement spoken portions and modifying one or more facial movements corresponding to the one or more spoken portions with one or more replacement facial movements corresponding to the one or more replacement spoken portions at 2224 may include replacing one or more words spoken in a first language with one or more replacement words spoken in a second language (e.g. replacing “no” with “nyet,” replacing “yes” with “oui,” etc.), and modifying one or more facial movements corresponding to the one or more words spoken in the first language with one or more replacement facial movements corresponding to the one or more words spoken in the second language (e.g. replacing facial movements corresponding to “no” with replacement facial movements corresponding to “nyet,” replacing facial movements corresponding to “yes” with replacement facial movements corresponding to “oui,” etc.) at 2226. Again, in this way, it will not be apparent to a viewer that an actor was originally speaking a first language but the movide has been dubbed with a second language, and instead, it will appear to the viewer that the actor was originally speaking the second language.

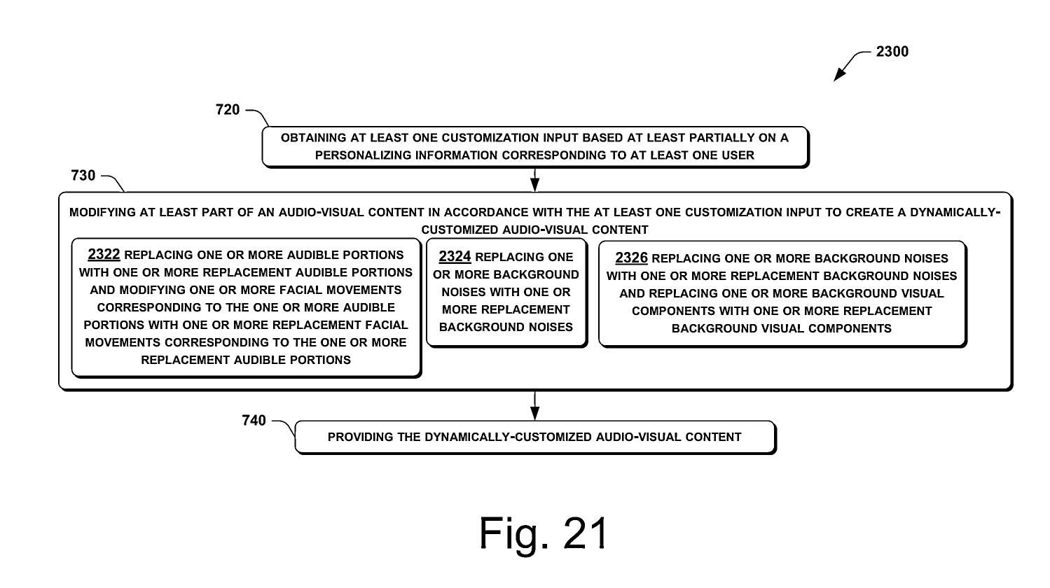

With reference to FIG. 21, in some implementations, modifying at least part of an audio-visual content in accordance with the at least one customization input to create a dynamically customized audio-visual content at 730 may include replacing one or more audible portions with one or more replacement audible portions (e.g. replacing a sound of a hand clap with a sound of snapping fingers, replacing a sound of a cough with a sound of a sneeze, replacing the sound of a piano with the sound of a violin, etc.) and modifying one or more body movements corresponding to the one or more audible portions with one or more replacement body movements corresponding to the one or more replacement audible portions (e.g. replacing two hands striking with two fingers snapping, replacing facial movements associated with a cough with facial movements associated with a sneeze, replacing visual components associated with a piano being played with replacement visual components associated with a violin being played, etc.) at 2322. Accordingly, by replacing both the audible and visual portions, it may not be apparent to the viewer that any changes have been made to the audio-visual core portion.

In other implementations, modifying at least part of an audio-visual content in accordance with the at least one customization input to create a dynamically customized audio-visual content at 730 may include replacing one or more background noises with one or more replacement background noises (e.g. replacing a sound of a bird singing with a sound of a dog barking, replacing a sound of an avalanche with a sound of an erupting volcano, etc.) at 2324.

In further implementations, modifying at least part of an audio-visual content in accordance with the at least one customization input to create a dynamically customized audio-visual content at 730 may include replacing one or more background noises with one or more replacement background noises (e.g. replacing a sound of a lion roaring with a sound of an elephant trumpeting, replacing a sound of an avalanche with a sound of an erupting volcano, etc.), and replacing one or more background visual components with one or more replacement background visual components (e.g. replacing a visual image of a lion roaring with a visual image of an elephant trumpeting, replacing a visual depiction of an avalanche with a visual depiction of an erupting volcano, etc.) at 2326.

It will be appreciated that systems and methods in accordance with the present disclosure may be utilized to adjust content (advertising or non-advertising content) to accommodate cultural differences. In some implementations, content that is categorized as being culturally inappropriate (e.g. vulgar, offensive, racist, derogatory, degrading, stereotypical, distasteful, etc.) may be either omitted (or deleted or removed), or may be replaced with alternate content that is categorized as being culturally appropriate, such as by retrieving replacement content from a library of lookup tables, or any other suitable source. For example, in some implementations, modifying at least part of an audio-visual content in accordance with the at least one customization input to create a dynamically customized audio-visual content at 730 may include at least one of replacing a culturally inappropriate portion with a culturally appropriate portion or omitting the culturally inappropriate portion (e.g. replacing terminology that may be considered a racial slur in a particular culture with replacement terminology that is not considered a racial slur in the particular culture, removing a content portion that includes a hand gesture that is insulting to a particular culture; etc.).

In other implementations, obtaining at least one customization input based at least partially on a personalizing information corresponding to at least one user at 720 may include receiving a selection signal indicative of a cultural heritage of at least one viewer, and modifying at least part of an audio-visual content in accordance with the at least one customization input to create a dynamically customized audio-visual content at 730 may include at least one of replacing a portion considered inappropriate with respect to the cultural heritage of the at least one viewer with a replacement portion considered appropriate with respect to the cultural heritage of the at least one viewer, or omitting the inappropriate portion (e.g. receiving a signal indicating that a viewer is Chinese, and replacing a reference to “Taiwan” with a reference to “Chinese Taipei;” receiving an indication that a viewer is Islamic, and replacing a reference to the Bible with a reference to the Quran; etc.).

In further implementations, obtaining at least one customization input based at least partially on a personalizing information corresponding to at least one user at 720 may include receiving a selection signal indicative of a geographic location of at least one viewer, and modifying at least part of an audio-visual content in accordance with the at least one customization input to create a dynamically customized audio-visual content at 730 may include at least one of replacing a portion considered inappropriate with respect to the geographic location of the at least one viewer with a replacement portion considered appropriate with respect to the geographic location of the at least one viewer, or omitting the inappropriate portion (e.g. receiving a signal, such as a GPS signal from a viewer's cell phone, indicating that the viewer is located in Brazil, and replacing a content portion that includes a hand gesture that is offensive in Brazil, such as a Texas Longhorns “hook-em-horns” hand gesture, with a benign hand gesture appropriate for the viewer located in Brazil; receiving a signal, such as a location of an IP address of a local Internet service provider, that indicates that a viewer is located within a Native American reservation, and replacing content that includes terminology offensive to Native Americans with replacement content that includes non-offensive terminology; etc.).

And in other implementations, obtaining at least one customization input based at least partially on a personalizing information corresponding to at least one user at 720 may include receiving a selection signal indicative of a cultural identity of at least one viewer, and modifying at least part of an audio-visual content in accordance with the at least one customization input to create a dynamically customized audio-visual content at 730 may include at least one of replacing at least a portion of content inappropriate for the cultural identity of the at least one viewer with an appropriate portion of content, or omitting the inappropriate portion (e.g. receiving a signal, such as a language selection of a software installed on a viewer's electronic device, indicating that the viewer is Arabic, and removing a content portion that is inappropriate to the Arabic culture; etc.).

It will be appreciated that modifying at least part of an audio-visual content in accordance with the at least one customization input to create a dynamically customized audio-visual content at 730 may be accomplished in various ways. For example, in some implementations, modifying at least part of an audio-visual content in accordance with the at least one customization input to create a dynamically customized audio-visual content at 730 may include one or more techniques disclosed in U.S. Pat. No. 8,059,201 issued to Aarts et al. (disclosing techniques for real-time and non-real-time rendering of video data streams), using wireframes and/or polygon modeling in accordance with one or more techniques disclosed in U.S. Pat. No. 8,016,653 issued to Pendleton et al. (disclosing techniques for three dimensional rendering of live events), U.S. Pat. Nos. 7,945,926 and 7,631,327 issued to Dempski et al. (disclosing techniques for video animation and merging with television broadcasts and supplemental content sources), U.S. Pat. Nos. 7,945,926 and 7,631,327 issued to Dempski et al. (disclosing techniques for video animation and merging with television broadcasts and supplemental content sources), U.S. Pat. No. 7,109,993 and U.S. Patent Publication No. 20070165022 by Peleg et al. (disclosing generating a head model and modifying portions of facial features), U.S. Pat. No. 6,054,999 issued to Strandberg (disclosing producing graphic movement sequences from recordings of measured data from strategic parts of actors), U.S. Pat. No. 5,926,575 issued to Ohzeki et al. (disclosing techniques for image deformation or distortion based on correspondence to a reference image, wire-frame modeling of images and texture mapping), U.S. Pat. No. 5,623,587 issued to Bulman (disclosing techniques for creation of composite electronic images from multiple individual images), U.S. Pat. No. 5,111,409 issued to Gasper et al. (disclosing techniques for synchronization of synthesized actors), U.S. Pat. Nos. 4,884,972 and 4,884,972 issued to Gasper (disclosing techniques for synchronization of animated objects), U.S. Pat. Nos. 4,827,532 and 4,600,281 and 4,260,229 issued to Bloomstein (disclosing techniques for substitution of sound track language and corresponding lip movements), U.S. Pat. No. 4,569,026 issued to Best (disclosing techniques for interactive entertainment systems), U.S. Patent Publication No. 20040181592 by Samra et al. (disclosing techniques for annotating and versioning digital media), U.S. Patent Publication No. 20110029099 by Benson (disclosing techniques for providing audio visual content), or any other suitable techniques or processes, which patents and pending patent applications are incorporated herein by reference.

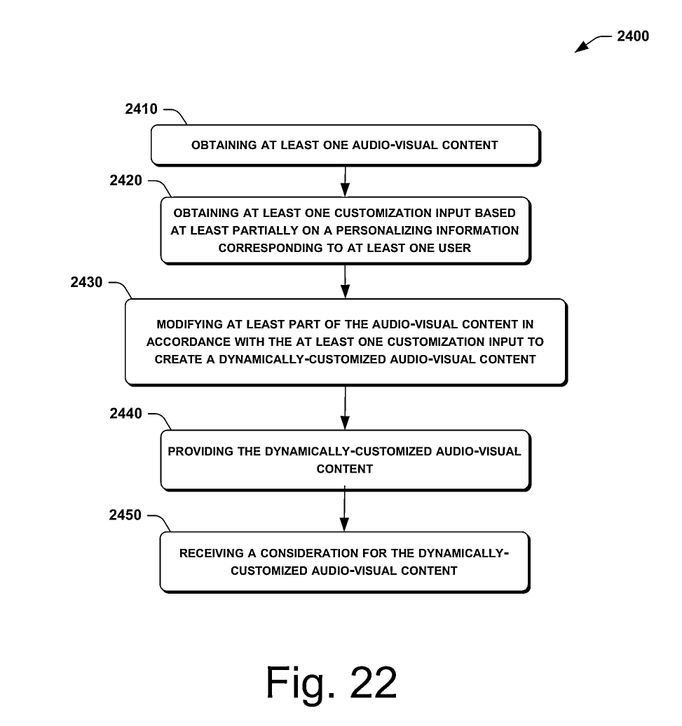

As shown in FIG. 22, in other implementations, a process in accordance with the teachings of the present disclosure includes obtaining at least one audio-visual content at 2410, obtaining at least one customization input based at least partially on a personalizing information corresponding to at least one user at 2420, modifying at least part of an audio-visual content in accordance with the at least one customization input to create a dynamically customized audio-visual content at 2430, providing the dynamically-customized audio-visual content at 2440, and receiving a consideration for the dynamically-customized audio-visual content at 2450. For example, in some implementations, receiving a consideration for the dynamically-customized audio-visual content at 2450 may include receiving at least one of a payment, a promise to pay, a promise to perform a deed, or a grant of a right.

It should be appreciated that the particular embodiments of processes described herein are merely possible implementations of the present disclosure, and that the present disclosure is not limited to the particular implementations described herein and shown in the accompanying figures. For example, in alternate implementations, certain acts need not be performed in the order described, and may be modified, and/or may be omitted entirely, depending on the circumstances. Moreover, in various implementations, the acts described may be implemented by a computer, controller, processor, programmable device, or any other suitable device, and may be based on instructions stored on one or more computer-readable media or otherwise stored or programmed into such devices. In the event that computer-readable media are used, the computer-readable media can be any available media that can be accessed by a device to implement the instructions stored thereon.

Various methods, systems, and techniques have been described herein in the general context of computer-executable instructions, such as program modules, executed by one or more processors or other devices. Generally, program modules include routines, programs, objects, components, data structures, etc. that perform particular tasks or implement particular abstract data types. Typically, the functionality of the program modules may be combined or distributed as desired in various alternate embodiments. In addition, embodiments of these methods, systems, and techniques may be stored on or transmitted across some form of computer readable media.

It may also be appreciated that there may be little distinction between hardware and software implementations of aspects of systems and methods disclosed herein. The use of hardware or software may generally be a design choice representing cost vs. efficiency tradeoffs, however, in certain contexts the choice between hardware and software can become significant. Those having skill in the art will appreciate that there are various vehicles by which processes, systems, and technologies described herein can be effected (e.g., hardware, software, firmware, or combinations thereof), and that a preferred vehicle may vary depending upon the context in which the processes, systems, and technologies are deployed. For example, if an implementer determines that speed and accuracy are paramount, the implementer may opt for a mainly hardware and/or firmware vehicle. Alternatively, if flexibility is paramount, the implementer may opt for a mainly software implementation. In still other implementations, the implementer may opt for some combination of hardware, software, and/or firmware. Hence, there are several possible vehicles by which the processes and/or devices and/or other technologies described herein may be effected, and which may be desired over another may be a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

Those skilled in the art will recognize that it is common within the art to describe devices and/or processes in the fashion set forth herein, and thereafter use standard engineering practices to integrate such described devices and/or processes into workable systems having the described functionality. That is, at least a portion of the devices and/or processes described herein can be developed into a workable system via a reasonable amount of experimentation.

The herein described aspects and drawings illustrate different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected” or “operably coupled” (or “operatively connected,” or “operatively coupled”) to each other to achieve the desired functionality, and any two components capable of being so associated can also be viewed as being “operably couplable” (or “operatively couplable”) to each other to achieve the desired functionality. Specific examples of operably couplable include but are not limited to physically mateable and/or physically interacting components and/or wirelessly interactable and/or wirelessly interacting components and/or logically interacting and/or logically interactable components.

Those skilled in the art will recognize that some aspects of the embodiments disclosed herein can be implemented in standard integrated circuits, and also as one or more computer programs running on one or more computers, and also as one or more software programs running on one or more processors, and also as firmware, as well as virtually any combination thereof. It will be further understood that designing the circuitry and/or writing the code for the software and/or firmware could be accomplished by a person skilled in the art in light of the teachings and explanations of this disclosure.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. For example, in some embodiments, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in standard integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure.

In addition, those skilled in the art will appreciate that the mechanisms of the subject matter described herein are capable of being distributed as a program product in a variety of forms, and that an illustrative embodiment of the subject matter described herein applies equally regardless of the particular type of signal bearing media used to actually carry out the distribution. Examples of a signal bearing media include, but are not limited to, the following: recordable type media such as floppy disks, hard disk drives, CD ROMs, digital tape, and computer memory; and transmission type media such as digital and analog communication links using TDM or IP based communication links (e.g., packet links).

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of this subject matter described herein. Furthermore, it is to be understood that the invention is defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.).

As a further example of “open” terms in the present specification and claims, it will be understood that usage of a language construction “A or B” is generally interpreted as a non-exclusive “open term” meaning. A alone, B alone, and/or A and B together.

Although various features have been described in considerable detail with reference to certain preferred embodiments, other embodiments are possible. Therefore, the spirit or scope of the appended claims should not be limited to the description of the embodiments contained herein.

1. A method of providing audio-visual content, comprising:
obtaining at least one customization input based at least partially on a personalizing information corresponding to at least one user;
modifying at least part of an audio-visual content in accordance with the at least one customization input to create a dynamically customized audio-visual content; and
providing the dynamically-customized audio-visual content.

2. The method of claim 1, wherein obtaining at least one customization input based at least partially on a personalizing information corresponding to at least one user comprises:
obtaining at least one customization input based at least partially on an information record stored on an electronic device associated with at least one user.

3. The method of claim 1, wherein obtaining at least one customization input based at least partially on a personalizing information corresponding to at least one user comprises:
obtaining at least one customization input based at least partially on an information record communicated at least one of to or from an electronic device associated with of at least one user.

4. The method of claim 1, wherein obtaining at least one customization input based at least partially on a personalizing information corresponding to at least one user comprises:
obtaining at least one customization input based at least partially on an information record stored on a computing device associated with at least one user.

5. The method of claim 1, wherein obtaining at least one customization input based at least partially on a personalizing information corresponding to at least one user comprises:
obtaining at least one customization input based at least partially on an information record communicated at least one of to or from a computing device associated with at least one user.

6-9. (canceled)

10. The method of claim 1, wherein obtaining at least one customization input based at least partially on a personalizing information corresponding to at least one user comprises:
obtaining at least one customization input based at least partially on a photo at least one of stored on or communicated with an electronic device associated with at least one user.

11. The method of claim 1, wherein obtaining at least one customization input based at least partially on a personalizing information corresponding to at least one user comprises:
obtaining at least one customization input based at least partially on a browsing dataum at least one of stored on or communicated with an electronic device associated with at least one user.

12. The method of claim 1, wherein obtaining at least one customization input based at least partially on a personalizing information corresponding to at least one user comprises:
obtaining at least one customization input based at least partially on a purchase record at least one of stored on or communicated with an electronic device associated with at least one user.

13. The method of claim 1, wherein obtaining at least one customization input based at least partially on a personalizing information corresponding to at least one user comprises:
obtaining at least one customization input based at least partially on a call record at least one of stored on or communicated with an electronic device associated with at least one user.

14-17. (canceled)

18. The method of claim 1, wherein obtaining at least one customization input based at least partially on a personalizing information corresponding to at least one user comprises:
obtaining at least one customization input based at least partially on a navigational datum at least one of stored on or communicated with an electronic device associated with at least one user.

19. The method of claim 1, wherein obtaining at least one customization input based at least partially on a personalizing information corresponding to at least one user comprises:
obtaining at least one customization input based at least partially on a communication datum at least one of stored on or communicated with an electronic device associated with at least one user.

20. The method of claim 1, wherein obtaining at least one customization input based at least partially on a personalizing information corresponding to at least one user comprises:
obtaining at least one customization input based at least partially on a downloaded content at least one or stored on or communicated with an electronic device associated with at least one user.

21. The method of claim 1, wherein obtaining at least one customization input based at least partially on a personalizing information corresponding to at least one user comprises:
obtaining at least one customization input based at least partially on a demographic information at least one of stored on or communicated with an electronic device associated with at least one user.

22-25. (canceled)

26. The method of claim 1, wherein obtaining at least one customization input based at least partially on a personalizing information corresponding to at least one user comprises:
obtaining at least one customization input based at least partially on an information record at least one of stored on or communicated with a cellular telephone associated with at least one user.

27. The method of claim 1, wherein obtaining at least one customization input based at least partially on a personalizing information corresponding to at least one user comprises:
obtaining at least one customization input based at least partially on an information record at least one of stored on or communicated with a tablet associated with at least one user.

28. The method of claim 1, wherein obtaining at least one customization input based at least partially on a personalizing information corresponding to at least one user comprises:
obtaining at least one customization input based at least partially on an information record at least one of stored on or communicated with an electronic reader associated with at least one user.

29. The method of claim 1, wherein obtaining at least one customization input based at least partially on a personalizing information corresponding to at least one user comprises:
obtaining at least one customization input based at least partially on an information record at least one of stored on or communicated with a gaming device associated with at least one user.

30-33. (canceled)

34. The method of claim 1, wherein obtaining at least one customization input based at least partially on a personalizing information corresponding to at least one user comprises:
obtaining at least one customization input based at least partially on an information record at least one of stored on or communicated with a personal digital assistant associated with at least one user.

35. The method of claim 1, wherein obtaining at least one customization input based at least partially on a personalizing information corresponding to at least one user comprises:
obtaining at least one customization input based at least partially on an information record at least one of stored on or communicated with a communication device associated with at least one user.

36. The method of claim 1, wherein obtaining at least one customization input based at least partially on a personalizing information corresponding to at least one user comprises:
obtaining at least one customization input based at least partially on an information record at least one of stored on or communicated with a navigational device associated with at least one user.

37. The method of claim 1, wherein obtaining at least one customization input based at least partially on a personalizing information corresponding to at least one user comprises:
obtaining at least one customization input based at least partially on an information record at least one of stored on or communicated with a monitoring device associated with at least one user.

38-78. (canceled)

79. A system for providing audio-visual content, comprising:
means for obtaining at least one customization input based at least partially on a personalizing information corresponding to at least one user;
means for modifying at least part of an audio-visual content in accordance with the at least one customization input to create a dynamically customized audio-visual content; and
means for providing the dynamically-customized audio-visual content.

80-156. (canceled)

157. One or more non-transitory computer-readable media bearing instructions that, when executed, perform a process of providing audio-visual content, the process comprising:
obtaining at least one customization input based at least partially on a personalizing information corresponding to at least one user;
modifying at least part of an audio-visual content in accordance with the at least one customization input to create a dynamically customized audio-visual content; and
providing the dynamically-customized audio-visual content.

158. (canceled)
